(19) United States
(12) Patent Application Publication
(10) Pub. No.: US 2014/0321338 A1
(43) Pub. Date: Oct. 30, 2014

(54) METHOD AND APPARATUS FOR APPLYING PUSCH/PHICH SCHEDULING TIMING IN INTER-BAND TDD TRANSMISSION SCHEMES

(71) Applicant: Pantech Co., Ltd., Seoul (KR)

(72) Inventors: Dong Hyun Park, Seoul (KR); Kyoungmin Park, Seoul (KR)

(21) Appl. No.: 14/368,756

(22) PCT Filed: Dec. 18, 2012
(86) PCT No.: PCT/KR2012/011093

§ 371 Date: Jun. 25, 2014

(30) Foreign Application Priority Data
Dec. 27, 2011 (KR) 10-2011-0143870
Jan. 27, 2012 (KR) 10-2012-0008566
Feb. 20, 2012 (KR) 10-2012-0016899

(51) Int. Cl. H04W 72/14; H04B 1/00

(52) U.S. Cl. CPC H04W 72/14; H04B 1/005; H04W 72/0446
USPC 370/280

(57) ABSTRACT

The present invention relates to a method and apparatus for applying PUSCH/PHICH scheduling timing in inter-band TDD transmission schemes. According to an embodiment of the present invention, the method for applying PUSCH/PHICH scheduling timing in inter-band TDD transmission schemes by a base station for controlling two or more different TDD bands includes the steps of: selecting a reference Physical Uplink Shared Channel (PUSCH)/Physical Hybrid ARQ Indicator Channel (PHICH) scheduling the timing of a UE, which supports cross-carrier scheduling by using two or more serving cells; transmitting instruction information for instructing the selected reference PUSCH/PHICH scheduling timing to the UE; and allocating an uplink and/or transmitting a PHICH to the UE according to the reference PUSCH/PHICH scheduling timing.

### CROSS-REFERENCE TO RELATED APPLICATIONS

This application is the National Stage Entry of International Application PCT/KR2012/011093, filed on Dec. 18, 2012, and claims priority from and the benefit Korean Patent Application No. 10-2011-0143870, filed on Dec. 27, 2011, Korean Patent Application No. 10-2012-0008566, filed on Jan. 27, 2012, and Korean Patent Application No. 10-2012-0016899, filed on Feb. 20, 2012, all of which are hereby incorporated by reference for all purposes as if fully set forth herein.

### BACKGROUND

1. Field

The present invention relates to a method and apparatus for supporting cross-carrier scheduling in an inter-band TDD (Time Division Duplex) transmission scheme, irrespective of a transmission mode of a user equipment. That is, herein will be described a method that overcomes a limit of a transmission and reception subframe and enables uplink scheduling in the state in which bands have different TDD transmission schemes and cross-carrier scheduling is set, and an apparatus embodying the method.

2. Discussion of the Background

As communication systems have developed, various wireless terminals have been utilized by consumers, such as companies and individuals. A current mobile communication system affiliated with 3GPP, for example, LTE (Long Term Evolution), LIE-A (LIE-Advanced), and the like, may be a high capacity communication system capable of transmitting and receiving various data, such as image data, wireless data, and the like, beyond providing a sound-based service. Accordingly, there is a desire for a technology that transmits high capacity data that is comparable to a wired communication network. Data may be efficiently transmitted through a plurality of component carriers as a scheme for transmitting high capacity data. A TDD (Time Division Duplex) system uses a predetermined frequency band for transmission (Tx) and Reception (Rx), and may transmit and receive data based on a time slot.

In a multiple carrier aggregation (Carrier Aggregation, or carrier coupling, “CA”) environment, in which one or more component carriers (CC) are coupled, a band where each component carrier belongs may be different from one another. That is, in a case in which carriers are coupled based on an inter-band scheme, when TDD configurations of each band are different from one another, a transmission and reception subframe may be limited based on a transmission mode of a user equipment. The limitation may also affect transmission and reception scheduling. There is a need to minimize the effect from scheduling for effective transmission and reception.

### SUMMARY

Under an inter-band CA, when cross-carrier scheduling is set, a current PUSCH/PHICH timing is used, as it is, without wasting further resources, with respect to all user equipments, irrespective of a capability of a user equipment (Full duplex, Half duplex).

The present invention provides a reference PUSCH/PHICH timing (reference PUSCH/PHICH timing) that may be commonly used in a TDD under an inter-band CA, irrespective of a characteristic of a user equipment, so as to provide an optimal PUSCH/PHICH timing to all of the inter-band CA user equipments (i.e. half or full duplex UEs), and thereby providing an optimal system performance.

In accordance with an aspect of the present invention, there is provided a method of applying a PUSCH/PHICH (Physical Uplink Shared Channel/Physical Hybrid ARQ Indicator Channel) scheduling timing of a base station that controls two or more bands having different Time Division Duplex (TDD) configurations, based on an inter-band TDD transmission scheme, the method including: transmitting an uplink grant or a PHICH to a user equipment that supports cross-carrier scheduling using two or more serving cells; and receiving a PUSCH from the user equipment, based on at least one PUSCH/PHICH scheduling timing of the two or more serving cells, wherein a PUSCH/PHICH scheduling timing of a scheduling cell of the two or more serving cells is based on a PUSCH/PHICH scheduling timing that is based on a TDD configuration of the scheduling cell, and a PUSCH/PHICH scheduling timing of a scheduled cell is based on a predetermined PUSCH/PHICH scheduling timing.

In accordance with another aspect of the present invention, there is provided a method of applying a PUSCH/PHICH (Physical Uplink Shared Channel/Physical Hybrid ARQ Indicator Channel) scheduling timing of a user equipment that transmits and receives data in two or more bands having different TDD (Time Division Duplex) configurations, based on an inter-band TDD transmission scheme, the method including: receiving an uplink grant or a PHICH from a base station that supports cross-carrier scheduling using two or more serving cells; and transmitting a PUSCH to the base station based on at least one PUSCH/PHICH scheduling timing of the two or more serving cells, wherein a PUSCH/PHICH scheduling timing of a scheduling cell of the two or more serving cells is based on a PUSCH/PHICH scheduling timing that is based on a TDD configuration of the scheduling cell, and a PUSCH/PHICH scheduling timing of a scheduled cell is based on a predetermined PUSCH/PHICH scheduling timing.

In accordance with another aspect of the present invention, there is provided a base station that controls two or more bands having different TDD (Time Division Duplex) configurations, the base station including: a transmitting unit that transmits an uplink grant or a PHICH (Physical Hybrid ARQ Indicator Channel) to a user equipment that supports cross-carrier scheduling using two or more serving cells; a receiving unit that receives a PUSCH from the user equipment based on at least one PUSCH/PHICH scheduling timing of the two or more serving cells; and a controller that executes a control so that a PUSCH (Physical Uplink Shared Channel)/PHICH scheduling timing of a scheduling cell of the two or more serving cells is based on a PUSCH/PHICH scheduling timing that is based on a TDD configuration of the scheduling cell, and a PUSCH/PHICH scheduling timing of a scheduled cell is based on a predetermined PUSCH/PHICH scheduling timing.

In accordance with another aspect of the present invention, there is provided a user equipment that transmits and receives data in two or more bands having different TDD (Time Division Duplex) configurations, the user equipment including: a receiving unit that receives an uplink grant or a PHICH (Physical Hybrid ARQ Indicator Channel) from a base station that supports cross-carrier scheduling using two or more serving cells; a transmitting unit that transmits a PUSCH to the base station based on at least one PUSCH/PHICH scheduling timing of the two or more serving cells; and a controller that executes a control so that a PUSCH (Physical Uplink Shared Channel)/PHICH scheduling timing of a scheduling cell of the two or more serving cells is based on a PUSCH/PHICH scheduling timing that is based on a TDD configuration of the scheduling cell, and a PUSCH/PHICH scheduling timing of a scheduled cell is based on a predetermined PUSCH/PHICH scheduling timing.

### BRIEF DESCRIPTION OF THE DRAWINGS

FIG. 1 illustrates a wireless communication system according to embodiments of the present invention;

FIG. 2 illustrates an inter-band CA environment according to an embodiment of the present invention;

FIG. 3 is a diagram illustrating a CA between bands that have different TDD configurations according to an embodiment of the present invention;

FIG. 4 is a diagram illustrating an operation mode for each subframe based on a transmission mode of a user equipment under the inter-band CA environment of FIGS. 2 and 3;

FIG. 5 is a diagram illustrating a case in which a PUSCH/PHICH scheduling timing has no problem in a network environment where CCS is set;

FIG. 6 is a diagram illustrating a case in which a PUSCH/PHICH scheduling timing has a problem in a network environment where CCS is set;

FIG. 7 is a diagram illustrating another case in which a PUSCH/PHICH scheduling timing has a problem in a network environment where CCS is set;

FIG. 8 is a diagram illustrating a case in which a PUSCH/PHICH scheduling timing has a problem in a network environment, irrespective of whether CCS is set;

FIG. 9 is a diagram illustrating a case in which a PCell is TDD #1, an SCell is TDD #2, and a reference PUSCH/PHICH timing is TDD #0 according to an embodiment of the present invention;

FIG. 10 is a diagram illustrating a case in which a PCell is TDD #1, an SCell is TDD #2, and a reference PUSCH/PHICH timing is TDD #1 according to an embodiment of the present invention;

FIG. 11 is a diagram illustrating another case in which a PCell is TDD #1, an SCell is TDD #2, and a reference PUSCH/PHICH timing is TDD #0 according to an embodiment of the present invention;

FIG. 12 is a diagram illustrating another case in which a PCell is TDD #1, an SCell is TDD #2, and a reference PUSCH/PHICH timing is TDD #1 according to an embodiment of the present invention;

FIG. 13 is a diagram illustrating a case in which a PCell is TDD #5, an SCell is TDD #1, and a reference PUSCH/PHICH timing is TDD #6 according to an embodiment of the present invention;

FIG. 14 is a diagram illustrating a PHICH configuration in a UE of a full-duplex transmission mode;

FIG. 15 is a diagram illustrating cases that are classified based on characteristics of a scheduling cell and a scheduled cell;

FIG. 16 is a diagram illustrating a PUSCH/PHICH scheduling timing of a scheduled cell in a first case (Case A of FIG. 15);

FIG. 17 is a diagram illustrating a PUSCH/PHICH scheduling timing of a scheduled cell in a second case (Case B of FIG. 15);

FIG. 18 is a diagram illustrating a case in which a reference PUSCH/PHICH configuration is TDD #0, and “n+7” of Equation 1 is set, according to an embodiment of the present invention;

FIG. 19 is another diagram illustrating a case in which a reference PUSCH/PHICH configuration is TDD #0, and “n+7” of Equation 1 is set, according to an embodiment of the present invention;

FIG. 20 is a diagram illustrating a process in which an eNB executes signaling of reference PUSCH/PHICH scheduling timing information to a UE according to an embodiment of the present invention;

FIG. 21 is a diagram illustrating a process in which a base station provides a reference PUSCH/PHICH scheduling timing to a user equipment in an inter-band TDD transmission scheme, and accordingly, transmits an uplink grant and/or a PHICH, according to an embodiment of the present invention;

FIG. 22 is a diagram illustrating a process in which a user equipment of an inter-band TDD transmission scheme receives indication information associated with a reference PUSCH/PHICH scheduling timing from a base station, and accordingly, receives an uplink grant and/or a PHICH, according to an embodiment of the present invention;

FIG. 23 is a diagram illustrating a configuration of a base station according to an embodiment of the present invention;

FIG. 24 is a diagram illustrating a configuration of a user equipment according to an embodiment of the present invention; and

FIGS. 25 and 26 are block diagrams of a base station and a user equipment according to embodiments described with reference to FIGS. 15 through 17.

### DETAILED DESCRIPTION OF THE ILLUSTRATED EMBODIMENTS

Hereinafter, embodiments of the present invention will be described with reference to the exemplary drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

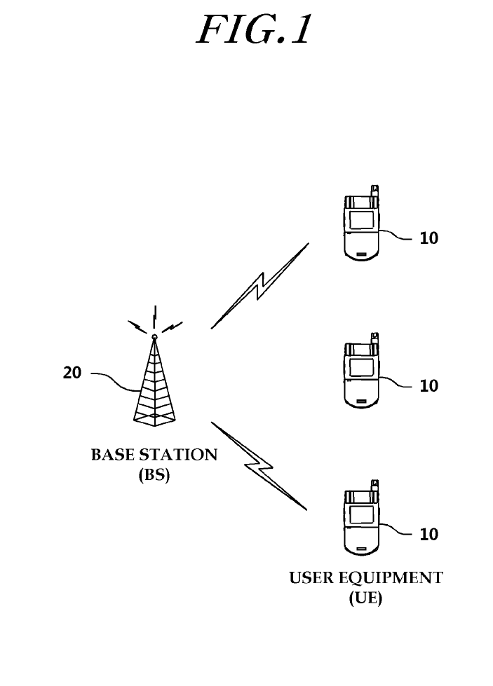

FIG. 1 illustrates a wireless communication system according to embodiments of the present invention.

The wireless communication system may be widely installed so as to provide various communication services, such as a voice service, packet data, and the like.

Referring to FIG. 1, the wireless communication system may include a User Equipment (UE) 10 and a Base Station (BS or eNB) 20. Throughout the specifications, the user equipment 10 may be an inclusive concept indicating a user terminal utilized in wireless communication, including a UE (User Equipment) in WCDMA, LTE, HSPA, and the like, and an MS (Mobile station), a UT (User Terminal), an SS (Subscriber Station), a wireless device, and the like in GSM.

The base station 20 or a cell, may generally refer to a station where communication with the user equipment 10 is performed, and may also be referred to as a Node-B, an eNB (evolved Node-B), a Sector, a Site, a BTS (Base Transceiver System), an Access Point, a Relay Node, and the like.

That is, the base station 20 or the cell may be construed as an inclusive concept indicating a portion of an area covered by a BSC (Base Station Controller) in CDMA, a NodeB in WCDMA, an eNB or a sector (site) in LIE, and the like, and the concept may include various coverage areas, such as a megacell, a macrocell, a microcell, a picocell, a femtocell, a communication range of a relay node, and the like.

In the specifications, the user equipment 10 and the base station 20 are used as two inclusive transceiving subjects to embody the technology and technical concepts described in the specifications, and may not be limited to a predetermined term or word. The user equipment 10 and the base station 20 are used as two (uplink or downlink) inclusive transceiving subjects to embody the technology and technical concepts described in the specifications, and may not be limited to a predetermined term or word. Here, the Uplink (UL) refers to a scheme of performing transmission and reception of data by the user equipment 10 with respect to the base station 20, and Downlink (DL) refers to a scheme of performing transmission and reception of data by the base station 20 with respect to the user equipment 10.

Varied multiple access schemes may be unrestrictedly applied to the wireless communication system. The wireless communication system may utilize varied multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like. An embodiment of the present invention may be applicable to resource allocation in an asynchronous wireless communication scheme that is advanced through GSM, WCDMA, and HSPA, to be LTE and LIE-advanced, and may be applicable to resource allocation in a synchronous wireless communication scheme that is advanced through CDMA and CDMA-2000, to be UMB. The present invention may not be limited to a specific wireless communication field, and may include all technical fields in which the technical idea of the present invention is applicable.

Uplink transmission and downlink transmission may be performed based on a TDD (Time Division Duplex) scheme that performs transmission based on different times, or based on an FDD (Frequency Division Duplex) scheme that performs transmission based on different frequencies.

Further, in a system such as LIE and LIE-A, a standard may be developed by configuring an uplink and a downlink based on a single carrier or a pair of carriers. The uplink and the downlink may transmit control information through a control channel, such as a PDCCH (Physical Downlink Control CHannel), PCFICH (Physical Control Format Indicator CHannel), PHICH (Physical Hybrid ARQ Indicator CHannel), PUCCH (Physical Uplink Control CHannel), and the like, and may be configured as a data channel, such as PDSCH (Physical Downlink Shared CHannel), PUSCH (Physical Uplink Shared CHannel), and the like, so as to transmit data.

Meanwhile, a timepoint of a downlink and a timepoint of an uplink may be distinguished in TDD, and when various TDD configurations exist, timepoints may be varied.

Table 1 below shows TDD configurations. It shows that a UL-DL subframe transmission timing is different for each TDD configuration.

TABLE 1
Uplink-downlink configurations

| | Downlink-to- | | | | | | | | | | | |
|---|---|---|---|---|---|---|---|---|---|---|---|---|
| Uplink- | Uplink | | | | | | | | | | | |
| downlink | Switch-point | | Subframe number | | | | | | | | | |
| Configuration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

In table 1, in a radio frame corresponding to 10 subframes, a region marked by D refers to a downlink and a region marked by U refers to an uplink S is a special subframe that is switched from a downlink to an uplink (Downlink-to-Uplink Switch-point periodicity).

When one of the TDD configurations is used, a user equipment may be aware in advance whether a downlink or an uplink comes at a corresponding timepoint. The information enables the user equipment to execute a prediction and to operate.

Meanwhile, a TDD configuration may be set to be different for each band. In some cases, a single user equipment uses the component carriers included in the bands having different TDD configurations.

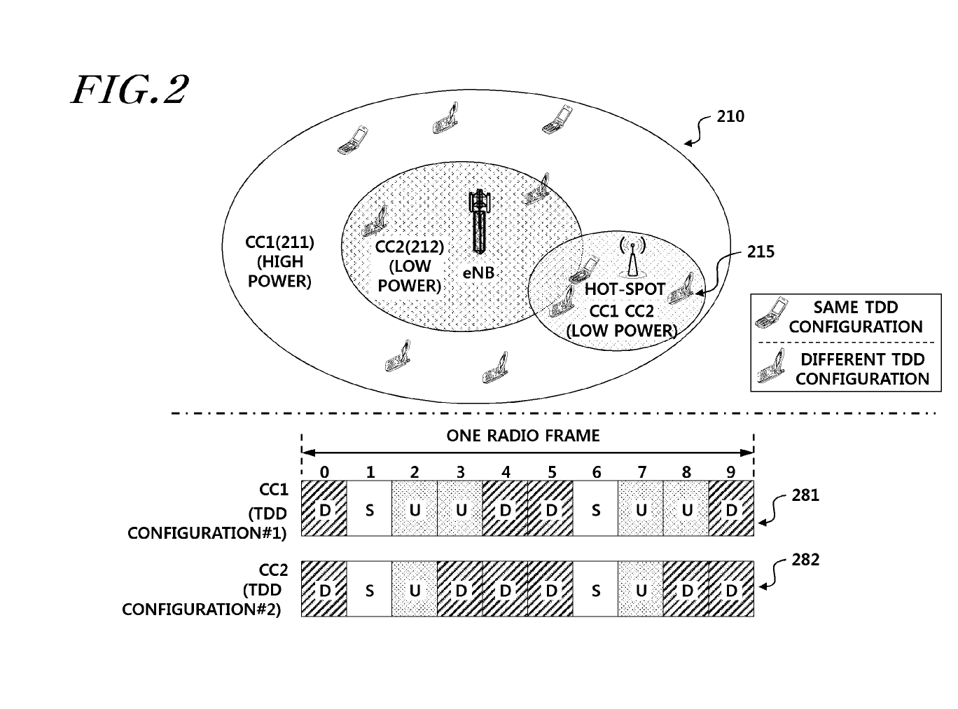

FIG. 2 illustrates an inter-band CA environment according to an embodiment of the present invention.

The diagram 210 shows that two component carriers are configured, and a CC1 211 is a carrier having coverage of a signal transmitted from an eNB with high power, and a CC2 212 is a carrier having coverage of a signal transmitted from an eNB with low power. The CC1 211 and the CC2 212 are included in different bands. A TDD configuration of the CC1 211 is 1 as shown in the diagram 281, and a TDD configuration of the CC2 212 is 2 as shown in the diagram 282. The diagram 215 corresponds to a hot-spot region, and is formed as a CA environment of the CC1 211 and the CC2 212. Also, the diagram 210 may form a CA for UEs included in a CC2 coverage.

Here, a user equipment that communicates with the hot-spot 215 may have different TDD configurations such as the CC1 211 and the CC2 212, and uplink subframes and downlink subframes of a few subframes may be set to be different for each component carrier.

In this example, an operation mode may be different for each subframe based on whether a transmission mode, supported by a user equipment, is a half-duplex or a fill duplex.

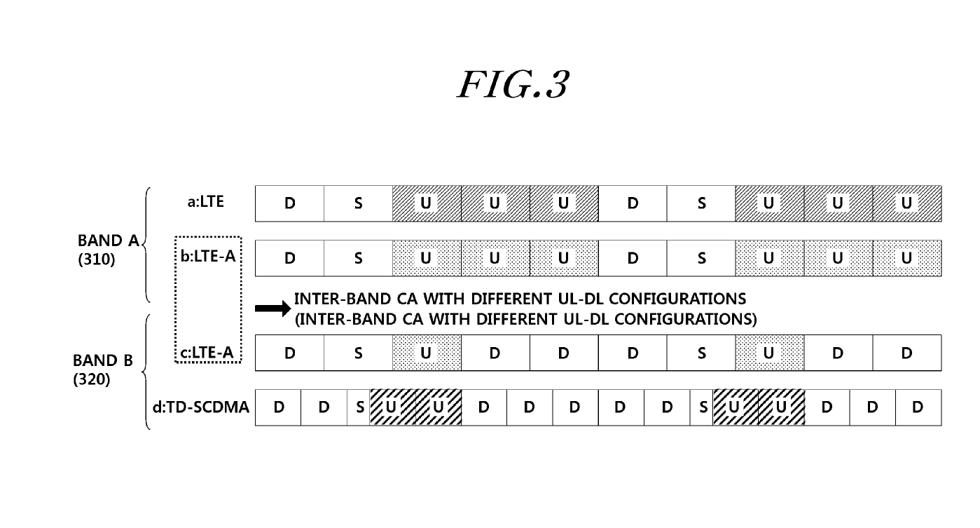

FIG. 3 is a diagram illustrating a CA between bands that have different TDD configurations according to an embodiment of the present invention.

FIG. 3 illustrates different TDD UL-DL configurations on an inter-band (different TDD UL-DL configuration on inter-band), which may be used for traffic adaptation.

To avoid interference issues occurring among different TDD systems, which co-exist (co-existence) in an identical band, different TDD UL-DL configurations may be needed in an inter-band CA.

A TDD UL-DL configuration that has many UL subframes may be used in a low frequency band, and a high frequency band may induce a TDD UL-DL configuration that has many DL subframes. The configuration may be helpful for coverage enhancement, and may also affect a peak throughput.

Referring to FIG. 3 in detail, the TDD configurations may be set to be identical or not to generate a conflict in a Band A 310 and a Band B 320. Therefore, a component carrier a of the Band A 310 operates in the LIE scheme and based on a TDD configuration 1 (TDD configuration #1), and a component carrier b operates in the LTE-A scheme and based on a TDD configuration 1. A component carrier c of the Band B 320 operates in the LIE-A scheme and based on the TDD configuration 2. Meanwhile, a component carrier d of the Band B 320 operates in a TD-SCDMA scheme. An identical TDD UL-DL configuration may be set in an identical band, or a band may be configured not to generate a conflict, such as component carriers c and d.

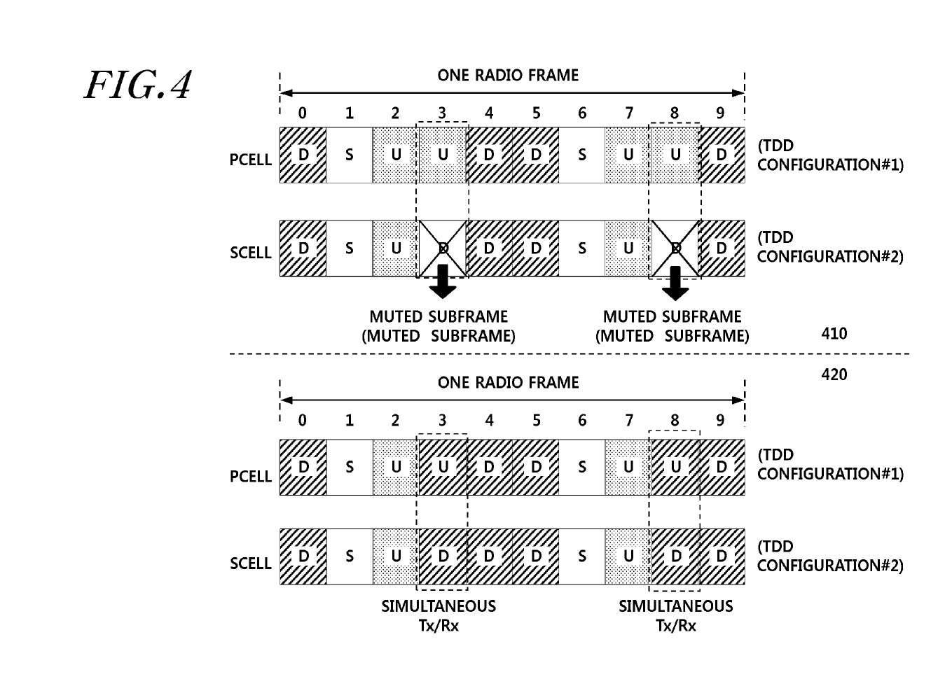

In this instance, in the case of a user equipment that has component carriers b and c as a CA, TDD configurations may be set to be different (inter-band CA with different UL-DL configurations). Based on whether the user equipment is a half-duplex transmission mode or a fill-duplex transmission mode, a few subframes are muted or execute simultaneous transmission and reception (simultaneous Tx/Rx), as shown in FIG. 4.

FIG. 4 is a diagram illustrating an operation mode for each subframe based on a transmission mode of a user equipment under the inter-band CA environment of FIGS. 2 and 3. It is the case in which a CC1 is a PCell (Primary Cell) and a CC2 is an SCell (Secondary Cell).

The diagram 410 of FIG. 4 shows that only an uplink subframe of a PCell operates in 3rd and 8th subframes of a radio frame and a downlink subframe of an SCell does not operate, that is, 3rd and 8th subframes of the SCell operate as muted subframes when a user equipment supports only a half-duplex transmission mode. In the diagram 410, the half-duplex transmission mode operates so that only one of a downlink and an uplink operates in a subframe (3rd and 8th subframes) where a downlink and an uplink conflict.

Conversely, the diagram 420 shows that both the uplink subframe of the PCell and the downlink subframe of the SCell operate in the 3rd and 8th subframes of the radio frame when the user equipment supports only a full-duplex transmission mode. That is, the full-duplex transmission mode simultaneously implements transmission and reception (Simultaneous Tx/Rx) and thus, an uplink/downlink may be implemented in the PCell and the Scell, respectively. In the diagram 420, the full-duplex transmission mode operates even in a subframe where a downlink and a uplink conflict and thus, both a downlink subframe and an uplink subframe may operate.

In the configuration of FIG. 4, in the case of user equipments of the half-duplex transmission mode, a reference TDD UL-DL configuration may be used. That is, information associated with which direction (an uplink or a downlink) is to be selected on a conflicting subframe may be selected (determined) based on the reference TDD UL-DL configuration information. In this example, due to the different TDD UL-DL configurations, problems associated with a HARQ timing, a scheduling timing, and the like may be raised.

TABLE 2
Setting of scheduling timing k in TDD
(PUSCH/PHICH scheduling timing in TDD)

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |

| | | | | | | | | |
|---|---|---|---|---|---|---|---|---|
| 0 | 4 | 6 | | | 4 | 6 | | |
| 1 | | 6 | | 4 | | 6 | | 4 |
| 2 | | | 4 | | | | 4 | |
| 3 | 4 | | | | | | 4 | 4 |
| 4 | | | | | | | 4 | 4 |
| 5 | | | | | | | 4 | |
| 6 | 7 | 7 | | | 7 | 7 | | 5 |

Table 2 is a table associated with a scheduling timing indicating that PUSCH transmission is executed in an n+k subframe when an uplink grant and/or a PHICH (UL grant and/or PHICH) is transmitted in a subframe n.

Table 3 may be obtained by coupling Table 1 and Table 2 and arranging PUSCH/PHICH scheduling timing based on UL/DL configurations.

TABLE 3
PUSCH/PHICH scheduling timing based on UL/DL configurations
(Uplink-downlink configurations with PUSCH/PHICH scheduling timing)

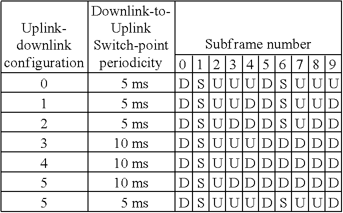

In Table 3, portions shown in gray indicate that a PUSCH/PHICH scheduling timing is set, and an uplink grant and/or a PHICH may be transmitted in the gray portions (UL grant and/or PHICH).

In the case in which different TDD configurations are set in different CCs that are considered in an inter-band CA environment of FIGS. 3 and 4, when cross-carrier scheduling (hereinafter, referred to as ‘CCS’) is set, a scheduling problem may be raised. As a matter of course, a scheduling problem may not occur for a UE for which CCS is not set, and an existing timing rule may be reused.

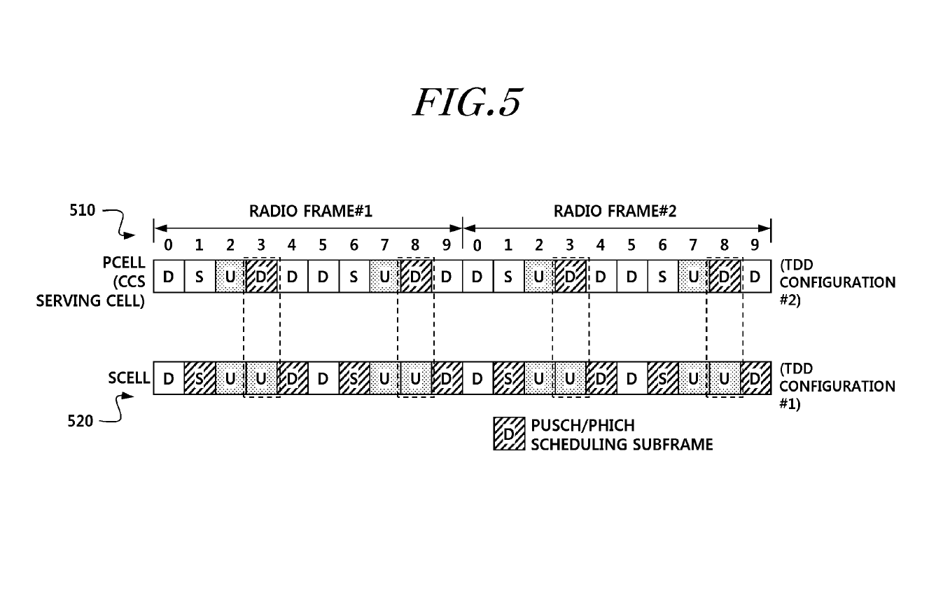

FIG. 5 is a diagram illustrating a case in which a PUSCH/PHICH scheduling timing has no problem in a network environment where CCS is set.

This may exemplify that the problem may not occur for a predetermined combination of TDD configurations or a predetermined UE type (for example, a full-duplex transmission mode or a half-duplex transmission mode), even though CCS is set.

As shown in FIG. 5, in the case in which CCS is set in a PCell (CCS Serving Cell) and a TDD configuration is set to be cell-specific in an inter-band CA environment, and TDD#2 (TDD configuration #2) is set for the PCell in the diagram 510 and TDD#1 (TDD configuration #1) is set for the SCell in the diagram 520, when a UE, which is a user equipment, is a full duplex transmission mode, a PUSCH/PHICH scheduling problem may not be raised. Both a downlink in the PCell and an uplink in the SCell may operate (full duplex) in the 3rd and 8th subframes where “an uplink grant/PHICH” is transmitted in TDD#2 as shown in the diagram 510 and thus, a scheduling problem may not be raised.

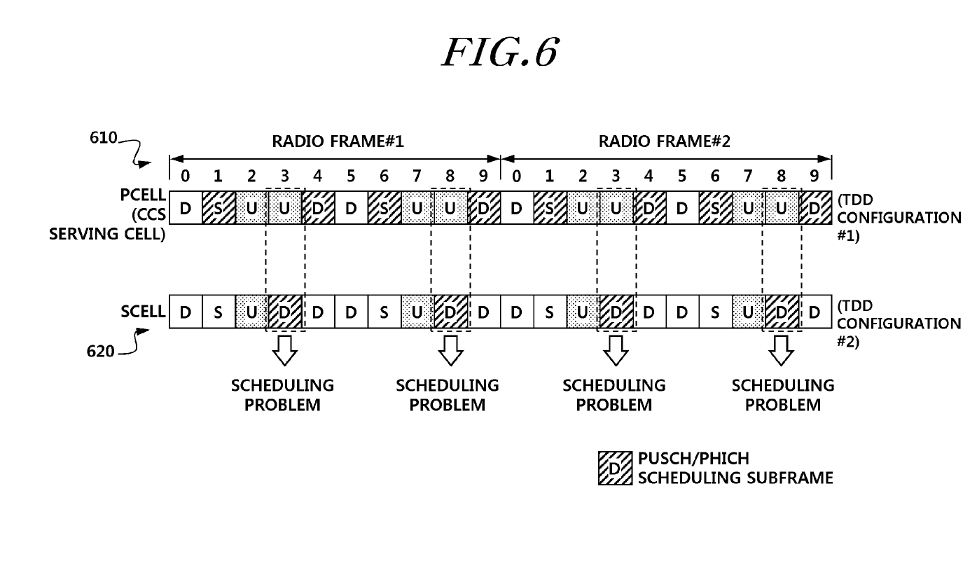

FIG. 6 is a diagram illustrating a case in which a PUSCH/PHICH scheduling timing has a problem in a network environment where CCS is set. FIG. 6 shows that it occurs in a UE of a full duplex transmission mode. Therefore, the problem of FIG. 6 also occurs in a UE of a half duplex transmission mode.

The diagrams 610 and 620 of FIG. 6 are a PCell of TDD#1 and an SCell of TDD#2, respectively. When the PCell and the SCell of FIG. 6 use PUSCH/PHICH timing used in corresponding TDD configurations, TDD #1 set for the PCell has a smaller number of DL subframes than TDD#2 set for the SCell and thus, when CCS is set on the PCell, there is a drawback in that the PUSCH/PHICH scheduling may not be executed for the PUSCH transmission that is transmitted over the SCell.

That is, in a subframe 3, the PCell is an uplink subframe and thus, the CCS for the PUSCH transmission of the SCell may not be executed. This may be the same in a subframe 8.

In other words, when CCS is set, a corresponding timing in the PCell is a subject of “UL grant and/or PHICH transmission” (UL grant and/or PHICH transmission), but the 3rd and 8th subframes, which are corresponding timings in the PCell, are UL subframes.

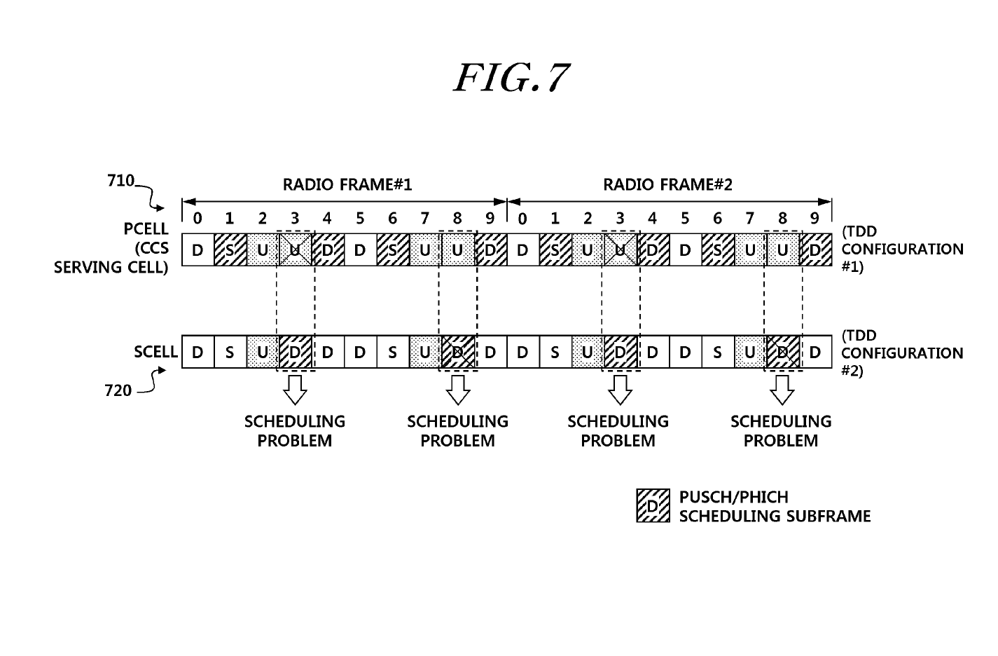

FIG. 7 is another diagram illustrating a case in which a PUSCH/PHICH scheduling timing has a problem in a network environment where CCS is set. FIG. 7 illustrates a problem occurring in a UE of a half duplex transmission mode.

The diagrams 710 and 720 of FIG. 7 are a PCell of TDD#1 and an SCell of TDD#2, respectively. When the PCell and the SCell of FIG. 7 use PUSCH/PHICH timing used in corresponding TDD configurations, TDD #1 set for the PCell has a smaller number of DL subframes than TDD#2 set for the SCell and thus, when CCS is set on the PCell, there is a drawback in that PUSCH/PHICH scheduling may not be executed.

That is, in a subframe 3, the PCell is an uplink subframe and thus, the CCS for the PUSCH transmission of the SCell may not be executed. This may be the same in a subframe 8.

In other words, when CCS is set, a corresponding timing in the PCell is a subject of “UL grant and/or PHICH transmission” (UL grant and/or PHICH transmission), but the 3rd and 8th subframes, which are corresponding timings in the PCell, are UL subframes.

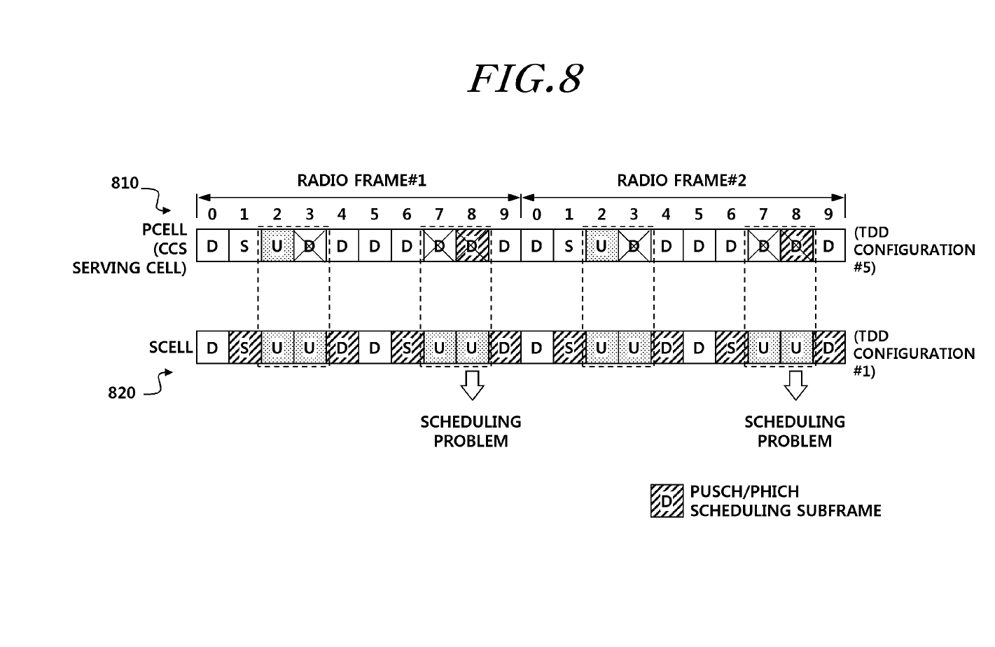

FIG. 8 is a diagram illustrating a case in which a PUSCH/PHICH scheduling timing has a problem in a network environment, irrespective of whether or not CCS is set. FIG. 8 illustrates a problem occurring in a UE of a half duplex transmission mode, and may be applied irrespective of whether or not CCS is set.

The diagrams 810 and 820 of FIG. 8 are a PCell of TDD#5 and an SCell of TDD#1, respectively.

The problem of FIG. 8 does not matter to a UE of a full duplex transmission mode. A PCell has more DL subframes than an SCell and thus, may maintain and use a PUSCH/PHICH timing of the SCell even when CCS is set. In the case in which CCS is not set, when a timing of the PCell is maintained, the problem may not be raised. However, the problem may be raised for a UE of a half duplex transmission mode. In the case in which a PUSCH/PHICH timing set on the PCell is used as it is when a DL subframe 8 of the PCell among conflicting subframes is muted, PUSCH transmission may not be executed in a UL subframe of a subframe 2 of the PCell.

The problem as described in FIGS. 6, 7, and 8, as described above, will occur equivalently in other combinations. Hereinafter, there will be described a method of configuring a common PUSCH/PHICH scheduling timing, irrespective of a capability of a UE (irrespective of whether a transmission mode is a full duplex transmission mode or a half duplex transmission mode), under the condition as described above, and a process and a configuration of signaling a corresponding configuration to each UE.

A method, described hereinafter, reuses a current PUSCH/PHICH timing without wasting further physical resources, for UEs of a half duplex or full duplex transmission mode when CCS is set, and applies a common method. Accordingly, a capability of a UE, which is in an inter-band CA, may be maximized, and the method may be applied to the situation in which two or more different TDD configurations are set and thus, may have expandability.

According to an embodiment of the present invention, a method of configuring a new PUSCH/PHICH timing will be described as follows. In the following embodiment, the descriptions will be provided based on two cells. However, the present invention may not be limited thereto, and may be applied to two or more cells.

First, an eNB compares TDD configurations, which are respectively set in corresponding serving cells (i.e. PCell and SCells).

The eNB detects a common downlink (DL) subframe (Common Downlink Subframe) from the two cells. A common DL subframe number for each TDD configuration, in DL subframes denoted by D/S in TDD configurations of Table 1 or Table 3, may be as shown in Table 4. In Table 4, values are identical based on the diagonal line, based on the characteristics of intersection. That is, the common DL subframes between PCell TDD configuration 2 and SCell TDD configuration 5 may be {0, 1, 3, 4, 5, 6, 8, 9}, which are identical to the common DL subframes between the PCell TDD configuration 5 and the SCell TDD configuration 2.

TABLE 4
Common DL subframe for each TDD configuration of PCell/SCell

| Common DL | | PCell TDD configuratio | | | | | | |
|---|---|---|---|---|---|---|---|---|
| Subframe (D/S) | | 0 | 1 | 2 | 3 | 4 | 5 | 6 |
| SCell TDD | 0 | 0, 1, 5, 6 | 0, 1, 5, 6 | 0, 1, 5, 6 | 0, 1, 5, 6 | 0, 1, 5, 6 | 0, 1, 5, 6 | 0, 1, 5, 6 |
| confoiguration | 1 | 0, 1, 5, 6 | 0, 1, 4, 5, | 0, 1, 4, 5, 6, | 0, 1, 5, 6, 9 | 0, 1, 4, 5, 6, | 0, 1, 4, 5, 6, 9 | 0, 1, 5, 6, 9 |
| | | | 6, 9 | 9 | | 9 | | |
| | 2 | 0, 1, 5, 6 | 0, 1, 4, 5, | 0, 1, 3, 4, 5, | 0, 1, 5, 6, 8, 9 | 0, 1, 4, 5, 6, | 0, 1, 3, 4, 5, 6, | 0, 1, 5, 6, 9 |
| | | | 6, 9 | 6, 8, 9 | | 8, 9 | 8, 9 | |
| | 3 | 0, 1, 5, 6 | 0, 1, 5, | 0, 1, 5, 6, 8, | 0, 1, 5, 6, 7, 8, | 0, 1, 5, 6, 7, | 0, 1, 5, 6, 7, 8, 9 | 0, 1, 5, 6, 9 |
| | | | 6, 9 | 9 | 9 | 8, 9 | | |
| | 4 | 0, 1, 5, 6 | 0, 1, 4, 5, | 0, 1, 4, 5, 6, | 0, 1, 5, 6, 7, 8, | 0, 1, 4, 5, 6, | 0, 1, 4, 5, 6, 7, 8, | 0, 1, 5, 6, 9 |
| | | | 6, 9 | 8, 9 | 9 | 7, 8, 9 | 9 | |
| | 5 | 0, 1, 5, 6 | 0, 1, 4, 5, | 0, 1, 3, 4, 5, | 0, 1, 5, 6, 7, 8, | 0, 1, 4, 5, 6, | 0, 1, 3, 4, 5, 6, 7, | 0, 1, 5, 6, 9 |
| | | | 6, 9 | 6, 8, 9 | 9 | 7, 8, 9 | 8, 9 | |
| | 6 | 0, 1, 5, 6 | 0, 1, 5, 6, 9 | 0, 1, 5, 6, 9 | 0, 1, 5, 6, 9 | 0, 1, 5, 6, 9 | 0, 1, 5, 6, 9 | 0, 1, 5, 6, 9 |

When the eNB detects common DL subframes for each TDD configuration, detects, from the common DL subframes, a reference PUSCH/PHICH timing that may be supportable through common DL subframes with reference to a PUSCH/PHICH timing supportable in each TDD configuration used in current Rel-8/9/10.

As described above, candidates of the reference PUSCH/PHICH timing (Candidates of Reference PUSCH/PHICH scheduling Timing) may be as shown in Table 5. The numbers in Table 5 indicate TDD configurations of Table 2 and Table 3.

TABLE 5
Candidates of reference PUSCH/PHICH timing (TDD configuration value)

| Reference | | | | | | | | |
|---|---|---|---|---|---|---|---|---|
| PUSCH/PHICH | | PCell TDD UL-DL configuration | | | | | | |
| timing candidates | | 0 | 1 | 2 | 3 | 4 | 5 | 6 |
| SCell TDD | 0 | 0 | 0 | 0 | 0 | 0 | 0 | 0 |
| UL-DL | 1 | 0 | 1 | 0, 1, 6 | 0, 6 | 0, 1, 6 | 0, 1, 6 | 0, 6 |
| confoiguration | 2 | 0 | 0, 1, 6 | 2 | 0, 3, 4, 5, 6 | 0, 1, 3, 4, 5, 6 | 0, 1, 2, 3, 4, 5, 6 | 0, 6 |
| | 3 | 0 | 0, 6 | 0, 3, 4, 5, 6 | 3 | 0, 3, 4, 5, 6 | 0, 3, 4, 5, 6 | 0, 6 |
| | 4 | 0 | 0, 1, 6 | 0, 1, 3, 4, 5, 6 | 0, 3, 4, 5, 6 | 4 | 0, 1, 3, 4, 5, 6 | 0, 6 |
| | 5 | 0 | 0, 1, 6 | 0, 1, 2, 3, 4, 5, 6 | 0, 3, 4, 5, 6 | 0, 1, 3, 4, 5, 6 | 5 | 0, 6 |
| | 6 | 0 | 0, 6 | 0, 6 | 0, 6 | 0, 6 | 0, 6 | 6 |

The values of Table 5 indicate TDD configuration values. When the eNB executes signaling of one of the candidates of Table 5 to a UE, the signaled timing is used as a reference PUSCH/PHICH timing. The eNB and the UE may execute uplink grant and/or PHICH transmission using the reference PUSCH/PHICH timing.

A signaling rule for signaling a value associated with the reference PUSCH/PHICH timing will be described.

Table 4 may be configured by the eNB, and the corresponding information may be set by the eNB based on a UE-specific method. Therefore, information associated with a reference PUSCH/PHICH timing selected based on the TDD configurations of the PCell and the SCell may be transmitted through a higher layer signaling (for example, RRC (Radio Resource Control)) or a PDCCH.

Additionally, the corresponding information may be in an offset form, and may indicate a configuration associated with a reference PUSCH/PHICH timing by providing an offset value based on a current PCell or SCell TDD configuration set to be cell specific. This may be applied to both the method based on an RRC and the method based on the PDCCH.

The eNB may appropriately predefine a PUSCH/PHICH timing based on a system bandwidth.

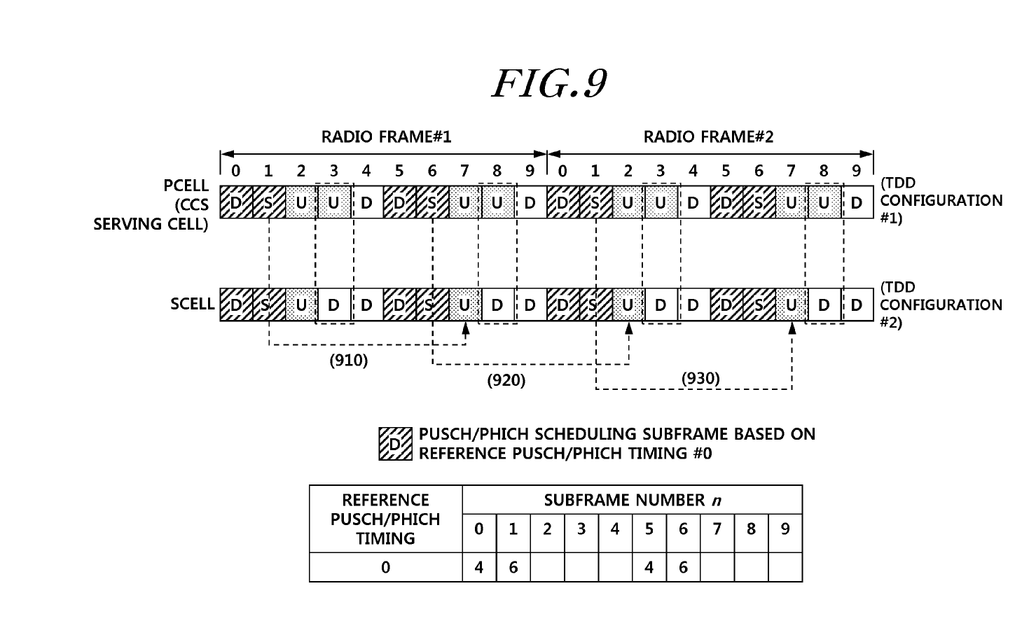

The described scheme will be applied to FIGS. 9 through 12.

In FIGS. 9 through 12, TDD#1 and TDD#2 (a PCell is set to TDD#1 and an SCell is set to TDD#2) are used, CCS is executed on the PCell, and scheduling with respect to PUSCH transmission transmitted over the SCell may be executed on the PCell. When TDD configurations of FIGS. 9 through 12 are applied to Table 4, common DL subframes may be #0, 1, 4, 5, 6, and 9.

The candidates of a reference PUSCH/PHICH timing of Table 5, which are the intersection of the common DL subframes and the gray portion of Table 3 (uplink grant and/or PHICH transmission subframes), may be TDD configurations #0, #1, and #6. Under the above assumption, the following example will be described.

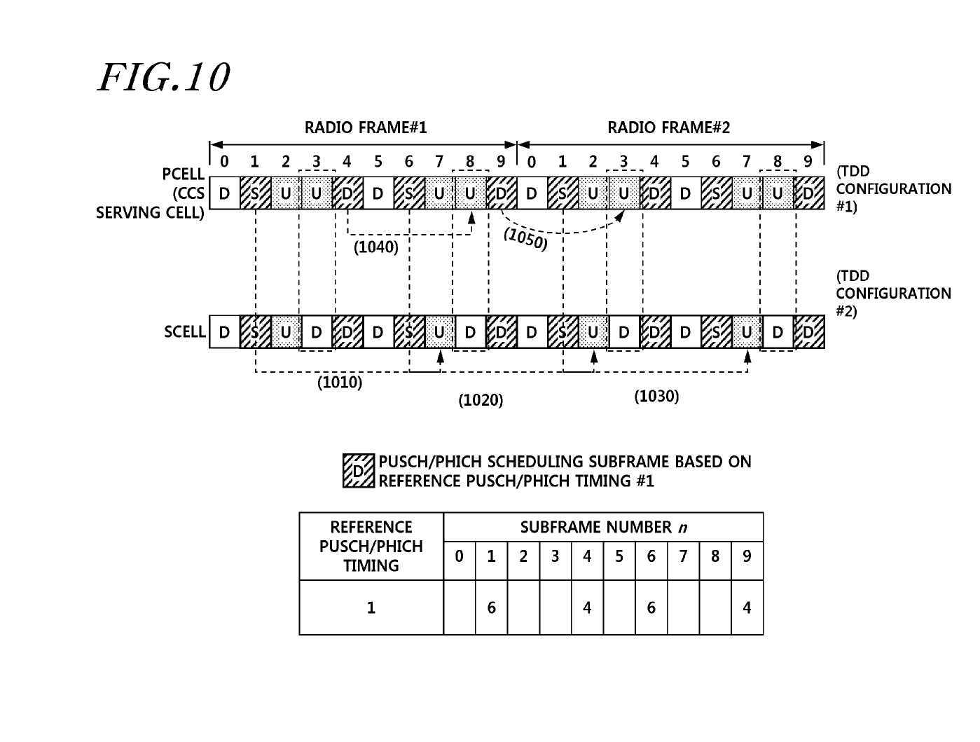

FIGS. 9 and 10 show that PUSCH/PHICH scheduling is available when an embodiment of the present invention is applied in an inter-band CA environment in which CCS is set without muting a conflicting subframe in a UE of a full duplex transmission mode.

FIG. 9 is a diagram illustrating a case in which a PCell is TDD #1, an SCell is TDD #2, and a reference PUSCH/PHICH timing is TDD #0 according to an embodiment of the present invention.

As illustrated in the diagrams 910 and 920 of FIG. 9, a reference PUSCH/PHICH timing is #0 for both the PCell and the SCell and thus, the PUSCH/PHICH scheduling is executed on subframes #0, #1, #5, and #6.

In FIG. 6, a subframe #3 of the PCell is used as a PUSCH/PHICH scheduling subframe to transmit a PUSCH on a subframe #7 of the SCell and a subframe #8 of the PCell is used as a PUSCH/PHICH scheduling subframe to transmit a PUSCH on a subframe #2 of the SCell. However, the PCell of FIG. 6 is TDD #1 and thus, there is a drawback in that the subframes #3 and #8 are uplink subframes. However, in FIG. 9, the reference PUSCH/PHICH timing is TDD #0 and thus, the subframes #1 and #6 of the PCell may be used. That is, when the reference PUSCH/PHICH timing is TDD#0, the following results may be obtained by applying TDD #0 of Table 2. When an uplink grant/PHICH is transmitted in the subframe #1 of the PCell, the PUSCH transmission may be executed in a subframe #7 of the SCell in operations 910 and 930. When an uplink grant/PHICH is transmitted in the subframe #6 of the PCell, the PUSCH transmission may be executed in a subframe #2 of a subsequent radio frame of the SCell in operation 920.

FIG. 10 is a diagram illustrating a case in which a PCell is TDD #1, an SCell is TDD #2, and a reference PUSCH/PHICH timing is TDD #1 according to an embodiment of the present invention. In FIG. 10, when the reference PUSCH/PHICH timing is TDD#1, following results may be obtained by applying TDD #1 of Table 2. When an uplink grant/PHICH is transmitted in a subframe #1 of the PCell, the PUSCH transmission may be executed in a subframe #7 of the SCell in operations 1010 and 1030. When an uplink grant/PHICH is transmitted in a subframe #6 of the PCell, the PUSCH transmission may be executed in a subframe #2 of a subsequent radio frame of the SCell in operations 1020. Also, in FIG. 10, an uplink grant/PHICH is transmitted in a subframe #4 of the PCell for the PUSCH transmission in a subframe #8 of the PCell, in operation 1040. In a DL subframe #9 of the PCell, PUSCH transmission may be scheduled for a subframe #3 of a radio frame #2 of the PCell in operation 1050. An SCell subframe #3 is a DL and thus, PUSCH transmission is scheduled only in a subframe #3 of the PCell.

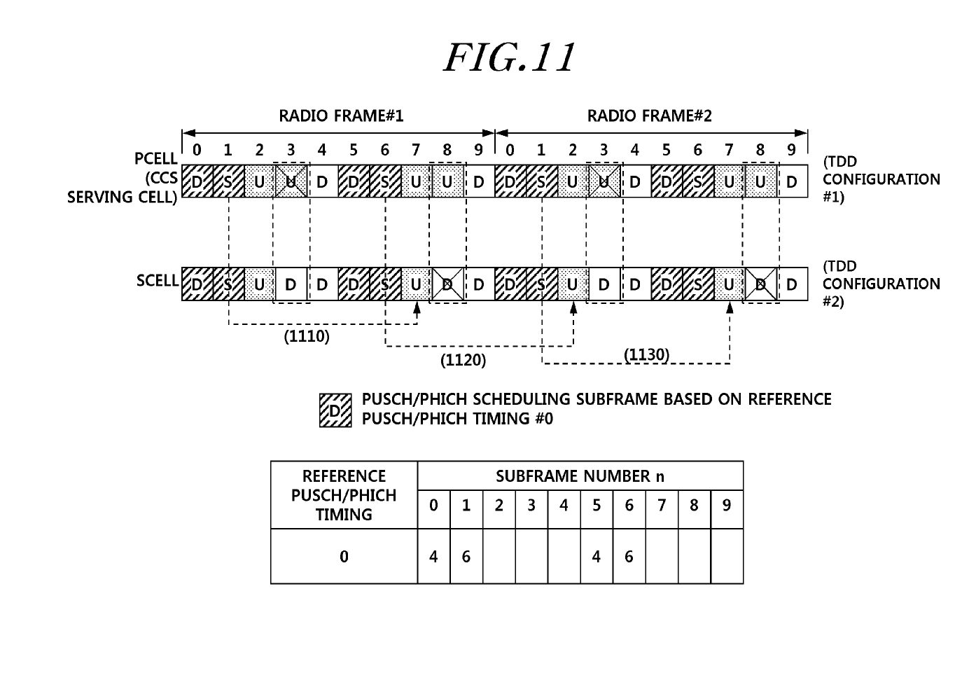

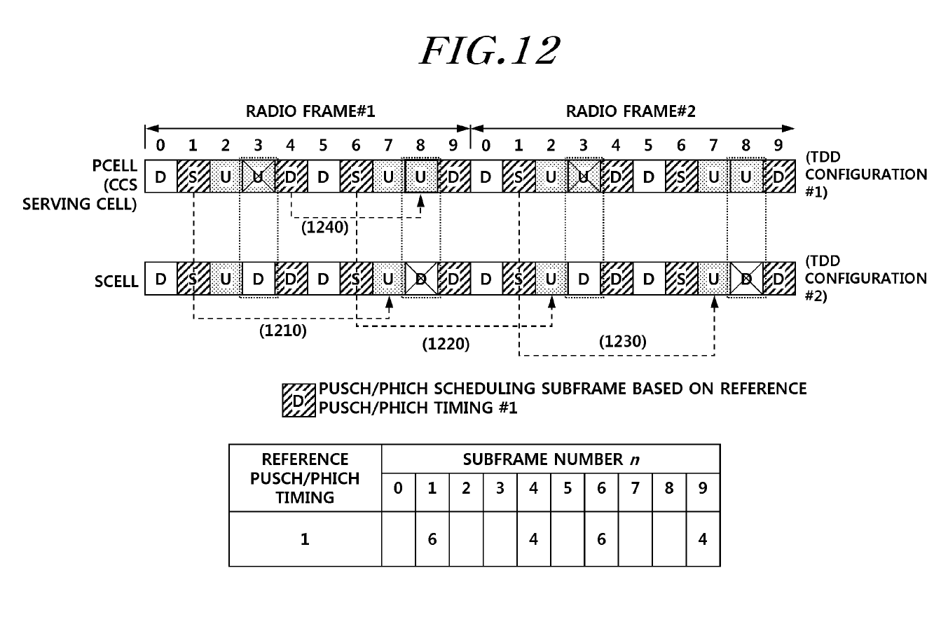

FIGS. 11 and 12 show that PUSCH/PHICH scheduling is available when an embodiment of the present invention is applied in an inter-band CA environment in which CCS is set in the state in which a UE of a half duplex transmission mode mutes a conflicting subframe.

FIG. 11 is a diagram illustrating a case in which a PCell is TDD #1, an SCell is TDD #2, and a reference PUSCH/PHICH timing is TDD #0 according to an embodiment of the present invention. A UE of a half duplex transmission mode may mute a conflicting subframe. A subframe #3 of the PCell and a subframe #8 of the SCell are muted. In this instance, when a reference PUSCH/PHICH timing TDD#0, which is an embodiment of the present invention, is applied, the following results are obtained. When an uplink grant/PHICH is transmitted in a subframe #1 of the PCell, the PUSCH transmission may be executed in a subframe #7 of the SCell in operations 1110 and 1130. When an uplink grant/PHICH is transmitted in a subframe #6 of the PCell, the PUSCH transmission may be executed in a subframe #2 of a subsequent radio frame of the SCell in operations 1120. As a matter of course, in the case of the subframes #1 and #6, both the PCell and the SCell are “S” subframes and thus, the muting problem occurring in the UE of the half duplex transmission mode may not occur.

FIG. 12 is a diagram illustrating a case in which a PCell is TDD #1, an SCell is TDD #2, and a reference PUSCH/PHICH timing is TDD #1 according to an embodiment of the present invention. A UE of a half duplex transmission mode may mute a conflicting subframe. A subframe #3 of the PCell and a subframe #8 of the SCell are muted. In this instance, when a reference PUSCH/PHICH timing TDD#1, which is an embodiment of the present invention, is applied, the following results are obtained. When an uplink grant/PHICH is transmitted in a subframe #1 of the PCell, the PUSCH transmission may be executed in a subframe #7 of the SCell in operations 1210 and 1230. When an uplink grant/PHICH is transmitted in a subframe #6 of the PCell, the PUSCH transmission may be executed in a subframe #2 of a subsequent radio frame of the SCell in operation 1220. As a matter of course, in the case of the subframes #1 and #6, both the PCell and the SCell are “S” subframes and thus, the muting problem occurring in the UE of the half duplex transmission mode may not occur. Also, for the PUSCH transmission in a subframe #8 of the PCell, an uplink grant/PHICH is transmitted in a subframe #4 of the PCell and the muting problem may not occur in the subframe #4.

When a PUSCH/PHICH timing TDD#0 or 1 is applied to embodiments of FIGS. 9 through 12 (PCell with TDD#1, SCell with TDD#2), it may be applicable irrespective of a full duplex/half duplex transmission mode of a UE.

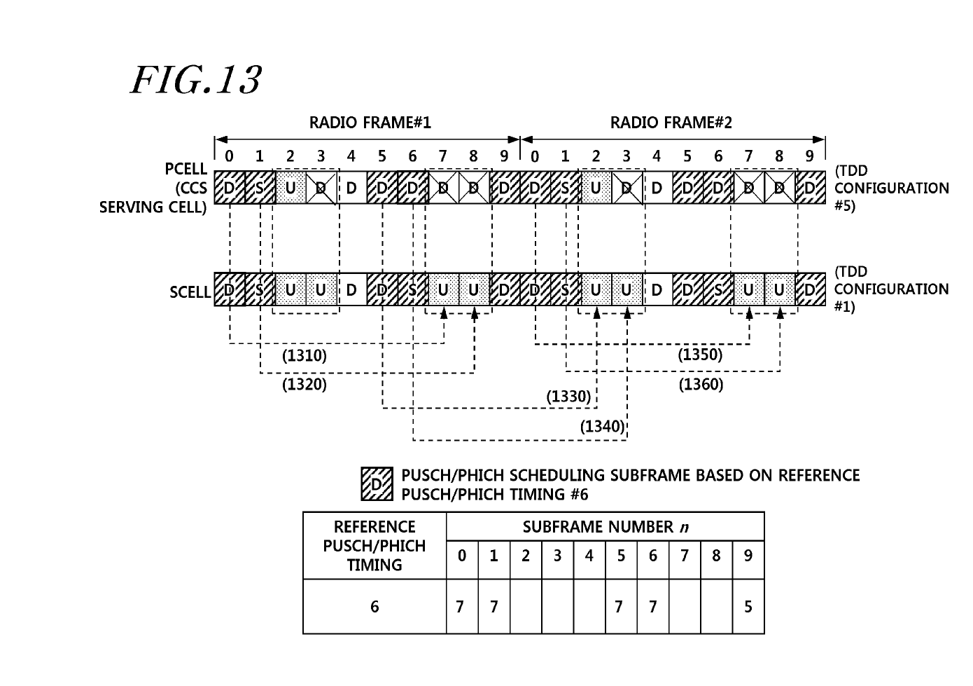

FIG. 13 is a diagram illustrating a case in which a PCell is TDD #5, an SCell is TDD #1, and a reference PUSCH/PHICH timing is TDD #6 according to an embodiment of the present invention.

A UE of a half duplex transmission mode may mute a conflicting subframe. Subframes #3, #7, and #8 of the PCell are muted.

The candidates of a reference PUSCH/PHICH timing may be 0, 1, and 6, based on Table 5, and a reference PUSCH/PHICH timing #6 is applied in FIG. 13.

Accordingly, unlike FIG. 4 in which the subframes #7 and #8 are muted and fail to operate as PUSCH/PHICH scheduling subframes, in FIG. 13, the subframes #5 and #6 of the PCell operate as PUSCH/PHICH scheduling subframes so as to transmit a PUSCH in the subframes #2 and #3 of the SCell, in operations 1330 and 1340. In the same manner, the subframes #0 and #1 of the PCell operate as PUSCH/PHICH scheduling subframes, for the PUSCH transmission in the subframes #7 and #8 of the SCell, in operations 1310, 1320, 1350, and 1360.

Additionally, although a common PHICH timing (=DL HARQ-ACK timing) of both a PCC (PCell) and an SCC (SCell) is considered, there is a drawback in that a solution is required for a backward compatibility (backward compatible) problem, for example, a problem caused by different understanding of a control region due to different PHICH timings between legacy UEs and Rel-11 UEs. According to another method, the PCC is based on a PHICH timing that is based on a TDD configuration. For the SCCs, common DL subframes are detected from TDD configurations of the PCC and the SCCs and a reference PHICH timing (reference PHICH timing, that is, detecting from an existing PHICH timing table) that supports a PHICH timing in a corresponding DL subframe is detected. The detected reference PHICH timing may be applied to only the SCCs. A DL subframe in which a PHICH of the PCC is transmitted is compared with DL subframes in which a PHICH of a PHICH timing, selected from among the reference PHICH timings, is transmitted, and cross-carrier scheduling is allowed only in a DL subframe having a common timing with the PHICH timing of the PCC, and self scheduling is executed in a DL subframe that does not has a common timing. That is, cross-carrier scheduling is partially allowed.

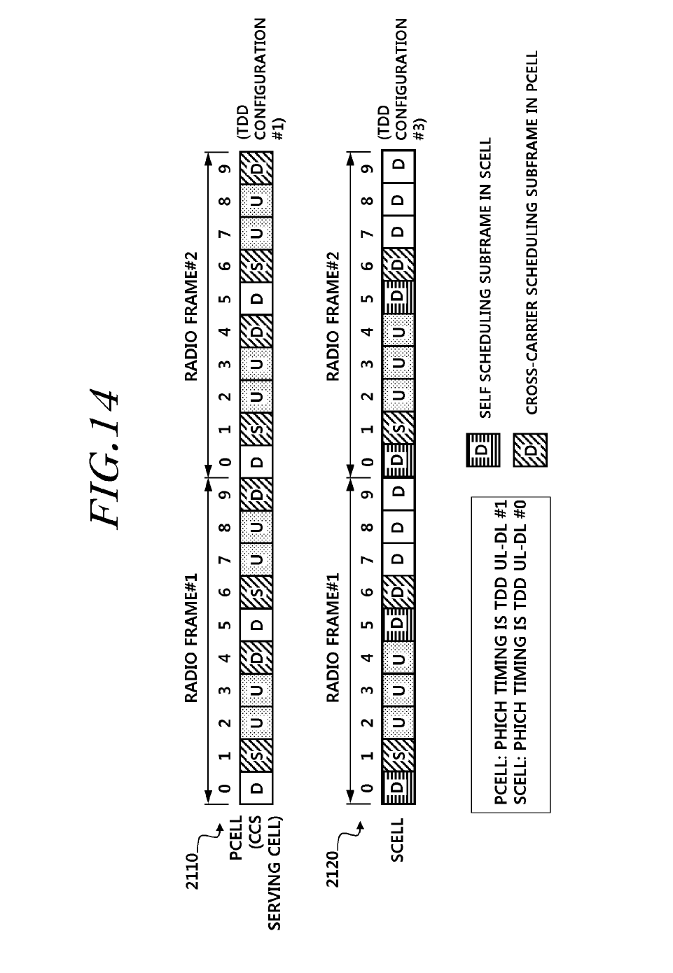

FIG. 14 is a diagram illustrating a PHICH configuration in a UE of a full-duplex transmission mode. A TDD configuration 2110 of a PCell (or PCC) is #1, and a TDD configuration 2120 of an SCell (or SCc) is #3. Accordingly, when a timing candidate value is selected by applying Table 5, TDD configurations #0 and #6 are drawn.

Here, the PCell (or PCC) maintains a PHICH timing of the TDD configuration 1, and the SCell (or SCC) applies Table 5 and selects a PHICH timing that may be applicable under the PCell (or PCC) and SCell (or SCC) configurations. That is, a scheme of obtaining candidates of a reference PUSCH/PHICH timing as shown in Table 5 using a TDD configuration value, may be applicable. This may indicate selecting a candidate of a common downlink HARQ-ACK timing with respect to the PCell and the SCell.

In FIG. 14, a PHICH timing (=DL HARQ-ACK timing) for the SCell (or SCCs) may be a PHICH timing of TDD configuration 0 or 6. However, to maintain backward compatibility, cross-carrier scheduling is allowed only in a DL subframe that corresponds to the PHICH timing of the PCC among the PHICH timing 0 or 6 applied to only the SCCs (that is, subframe #1, or 6, 9), and only self scheduling is supported in the subframes that do not correspond to the PHICH timing 0 or 6 (that is, subframes #0 and #5 in the case of the PHICH timing 0 or 6). The cross-carrier scheduling of the SCell (or SCCs) may be partially used by taking into consideration the PHICH timing of the PCell (or PCC). It is advantageous that the described method provides a DL HARQ operation through a PHICH (DL HARQ operation via PHICH) through a common method without deterioration of capacity of transmission modes (half or full duplex UE) of a UE, even under the condition in which different TDD UL-DL configurations are set. The full duplex transmission mode refers to a mode in which simultaneous transmission and reception are executed, and the half duplex transmission mode refers to a method in which both transmission and reception are available but only one of the transmission and the reception is executed at a point in time.

According to another method, when cross-carrier scheduling is set, there is provided a PUSCH/PHICH scheduling timing method based on a set of predetermined TDD UL-DL configuration combinations. A method provided under assumption that the PCell operates as a scheduling cell and the SCell is set to be a scheduled cell when cross-carrier scheduling is set, may be applied. As a matter of course, when two or more serving cells exist, a predetermined SCell operates as a scheduling cell of the remaining SCells (in this instance, at least a PCell and a predetermined SCell may be scheduling cells.) In the same manner, a scheduling cell (i.e. PCell) is always based on a PUSCH/PHICH scheduling timing of a TDD configuration of the scheduling cell.

However, for a PUSCH/PHICH scheduling timing of a scheduled cell (i.e. SCell), there are various methods based on various instances. In the following descriptions, a method of applying a PUSCH/PHICH scheduling timing for scheduled cells when different TDD UL-DL configurations are set and cross-carrier scheduling is set in a CA environment, will be described.

Hereinafter, there is described a PUSCH/PHICH scheduling timing applied to a scheduled cell of each of the four cases classified based on the characteristics of a scheduling cell and a scheduled cell. However, the present invention may not be limited to the following case classification method, and it should be construed that an identical PUSCH/PHICH scheduling timing is applied when a scheduling cell and a scheduled cell have a TDD configuration value, irrespective of the classified case. For example, although the description describes that a PUSCH/PHICH scheduling timing of a scheduled cell is set to 0 based on the scheduling cell, when describing the case in which the combination of the scheduling cell and the scheduled cell is (0,1) and classifying into the third case, the present invention may not be limited to the case classification. However, when the combination of the scheduling cell and the scheduled cell is (0,1), it should be construed that all of the PUSCH/PHICH scheduling timings of the scheduled cell having a configuration value 0 are included in the range of the present invention.

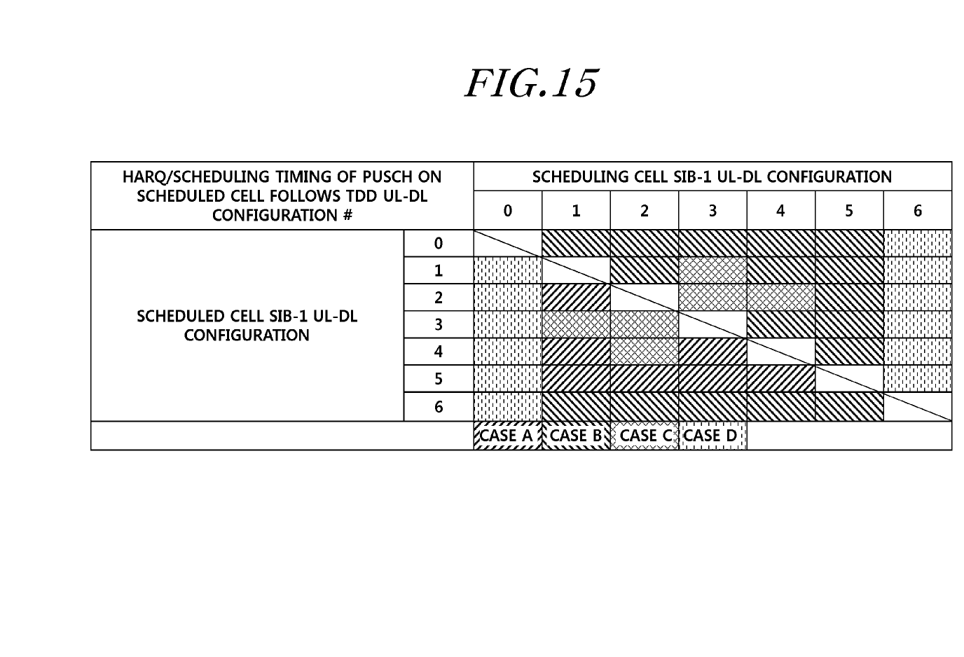

FIG. 15 is a diagram illustrating cases that are classified based on characteristics of a scheduling cell and a scheduled cell.

Referring to FIG. 15, the remaining combinations excluding the combinations in which a scheduling cell and a scheduled cell are identical, are classified into four cases, that is, Case A, Case B, Case C, and Case D.

A first case of the method of applying a PUSCH/PHICH scheduling timing to scheduled cells when different TDD UL-DL configurations are set and cross-carrier scheduling is set in a CA environment, corresponds to a case in which a scheduling cell has an uplink super set (UL super set), in comparison with a scheduled cell (for example, UL subframes of a PCell include all of the UL subframes of an SCell), and a case in which a PUSCH HARQ RTT (Round Trip Time) of a TDD configuration of the scheduling cell is 10 ms (that is, the case in which a pair of TDD configurations of the scheduling cell and the scheduled cell corresponds to (1,2), (1,4), (1,5), (2,5), (3,4), (3,5), or (4,5)) (Case A of FIG. 15). Here, the RTT refers to a time in which an eNB receives a PUSCH and A/N (Ack/NAck) information arrives to a UE, starting from a subframe in which a UL grant is transmitted for a first PUSCH transmission. In this instance, the PUSCH/PHICH scheduling timing of the scheduling cell (i.e. PCell) is applied to the scheduled cell (i.e. SCell).

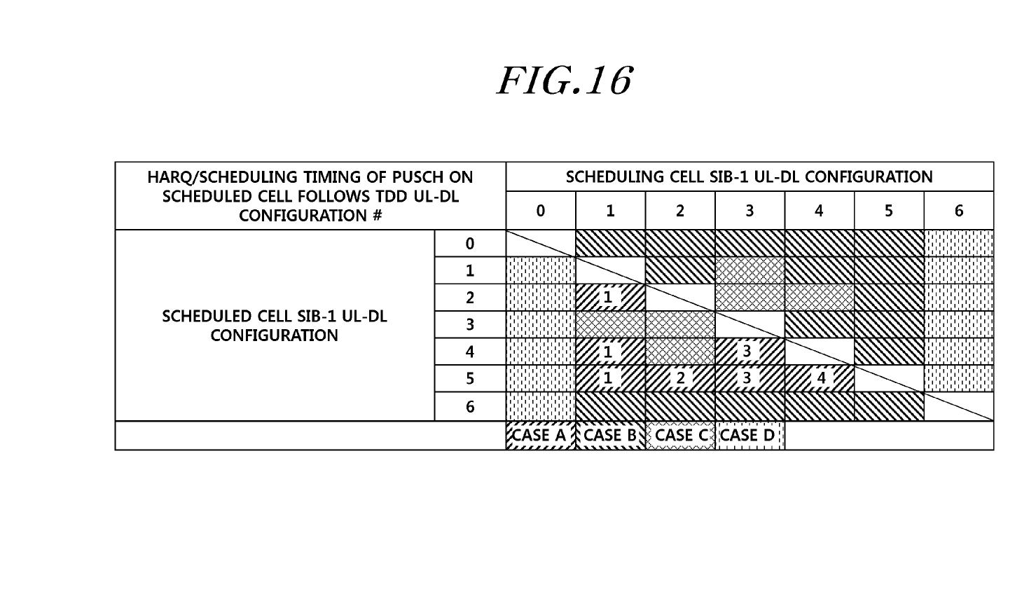

FIG. 16 is a diagram illustrating a PUSCH/PHICH scheduling timing of a scheduled cell in the first case (Case A of FIG. 15).

Referring to FIG. 16, when a pair of TDD configurations of the scheduling cell and the scheduled cell is (1,2), a PUSCH/PHICH scheduling timing of the scheduled cell may be a TDD UL-DL configuration value of 1 based on the scheduling cell. For the other pairs of TDD configurations corresponding to the first case, a PUSCH/PHICH scheduling timing of the scheduled cell is based on the scheduling cell.

A second case corresponds to a case in which a scheduling cell is an uplink subset (UL subset) in comparison with a scheduled cell, and a PUSCH HARQ RTT of a TDD UL-DL configuration of the scheduling cell is 10 ms (that is, the case in which a pair of TDD configurations of the scheduling cell and the scheduled cell is (1,0), (1,6), (2,0), (2,1), (2,6), (3,0), (3,6), (4,0), (4,1), (4,3), (4,6), (5,0), (5,1), (5,2), (5,3), (5,4), or (5,6)). In this instance, various methods may be applied (Case B of FIG. 15). As one of the methods, one of the methods a-i), a-ii), a-iii), and a-iv) may be applied. Hereinafter, each method will be described.

The method a-i) applies a PUSCH/PHICH scheduling timing of a scheduled cell to the scheduled cell to maintain a peak data rate.

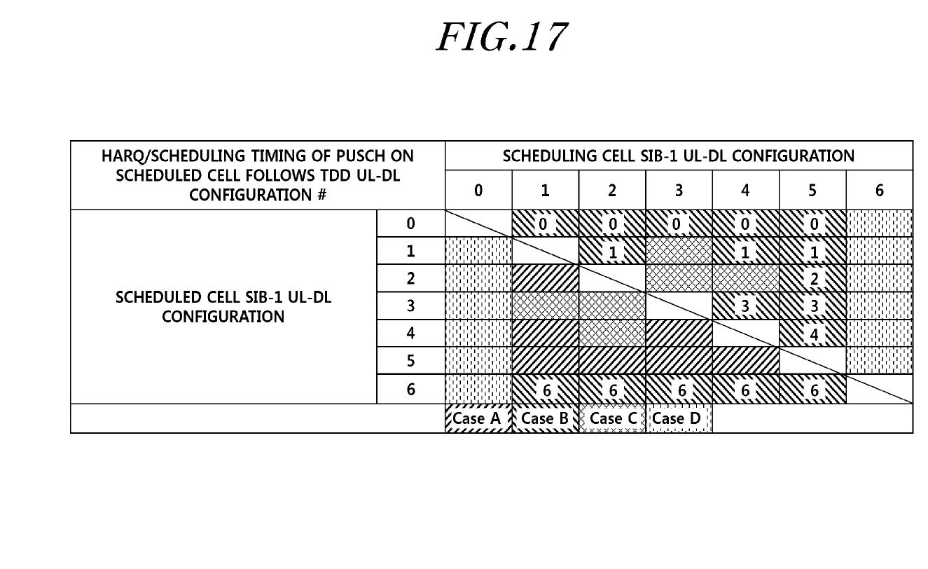

FIG. 17 is a diagram illustrating a PUSCH/PHICH scheduling timing of a scheduled cell in the second case (Case B of FIG. 15). FIG. 17 is based on the method a-i).

Referring to FIG. 17, when a pair of TDD configurations of a scheduling cell and a scheduled cell is (1.0), a PUSCH/PHICH scheduling timing of the scheduled cell may be a TDD UL-DL configuration value of 0 based on the scheduled cell. For the other pairs of TDD configurations corresponding to the second case, a PUSCH/PHICH scheduling timing of the scheduled cell is based on the scheduling cell.

The method a-ii) applies a reference PUSCH/PHICH scheduling timing to a scheduled cell. The reference PUSCH/PHICH scheduling timing is selected by an eNB, which is considered to be appropriate from among existing PUSCH/PHICH scheduling timings, and may be applied by being signaled to a UE through a higher layer signaling or dynamic signaling. In this instance, a corresponding signaling may be cell-specific or UE-specific. However, the methods a-i) and a-ii) may cause a conflict in resources due to different understandings of a control region between an existing Rel-8/9/10 UE and an Rel-11 UE, as described earlier. Therefore, to solve the problem, cross-carrier scheduling is allowed only in a DL subframe that has an identical scheduling timing to the scheduled cell from among DL subframes in which a PHICH and/or UL grant (PHICH and/or UL grant) is transmitted at the PUSCH/PHICH scheduling timing of the scheduling cell. The method a-iii) is based on a PUSCH/PHICH scheduling timing of a scheduling cell, in the same manner as the methods a-i) and a-ii). However, the method a-iii) is the most simplest method and does not cause a problem, but has a drawback in that a peak data rate is decreased. Lastly, the method a-iv) enables the above described methods a-i), a-ii), and a-iii) to be changed based on settings by an eNB. Therefore, the eNB may set an appropriate method from among the methods a-i), a-ii), and a-iii) by taking into consideration the capability of each UE or the like, and applies the same to each UE. In this example, there is a drawback in that a complexity of embodiment may increase.

A third case corresponds to a case in which a PUSCH HARQ RTT of a scheduling cell is not 10 ms. (that is, a pair of TDD configurations of a scheduling cell and a scheduled cell is (0,1), (0,2), (0,3), (0,4), (0,5), (0,6), (6,0), (6,1), (6,2), (6,3), (6,4), or (6,5)). In this case, to prevent problems that may be additionally caused, a PUSCH/PHICH scheduling timing of a scheduling cell may be used (Case D of FIG. 15). The case of (6.0), that is, the case in which a TTD UL-DL configuration of the scheduling cell is 6, and that of the scheduled cell is 0, may be exceptional. In this case, a PUSCH/PHICH scheduling timing of the scheduled cell may be used.

A fourth case corresponds to a case in which a correlation between TDD UL-DL configurations of a scheduling cell and a scheduled cell has the lowest value. That is, this corresponds to an embodiment in which a pair of TDD configurations of the scheduling cell and the scheduled cell corresponds to a combination of (1,3), (2,3), (2,4), (3,1), (3,2), or (4,2) (Case C of FIG. 15). Basically, the combinations may be classified as combinations, which are not supported, so as to reduce the complexity of embodiment of a system. However, when more TDD UL-DL configuration combinations are supported, the following method may be applied. In this example, a PUSCH/PHICH scheduling timing of the scheduled cell may be based on a HARQ timing of the scheduling cell. Alternatively, as a HARQ timing of the scheduled cell, a PUSCH HARQ timing of the scheduled cell may be applied by allowing cross-carrier scheduling only in limited DL subframes. Here, the limited DL subframes have been described earlier. The PUSCH/PHICH scheduling timing of the scheduled cell and the PUSCH/PHICH scheduling timing of the scheduling cell are compared and, when a PHICH/UL grant transmission timing of the scheduled cell is different from that of the scheduling cell, cross-carrier scheduling for the scheduled cell is not allowed in a corresponding DL. Also, when the scheduled cell is a DL subframe and the scheduling cell is a UL subframe in a predetermined subframe, cross-carrier scheduling may not be executed physically. Accordingly, the cross-carrier scheduling is not allowed.

Although the term, PUSCH/PHICH scheduling timing, has been described, the present invention may not be limited thereto. The PUSCH/PHICH scheduling timing may be interchangeable with the term, PUSCH HARQ timing, and also, may be interchangeable with the term, HARQ/PUSCH scheduling timing. Also, simply, the term, PUSCH/PHICH timing or HARQ/PUSCH timing, may be used.

When a TDD configuration is 0 under a TDD environment, an additional operation may be added and the same may be applied to a reference PUSCH timing.

That is, when the TDD configuration is 0 (TDD #0), the number of uplink subframes is greater than the number of downlink subframes and thus, multiple uplink grant scheduling (multiple UL grant scheduling) may be possible in a single downlink subframe. This is related to a PDCCH through which an uplink grant is transmitted. In the case of a PHICH, information indicating an uplink subframe corresponding to a PUSCH for which an A/N is transmitted may be signaled based on a predetermined parameter value. Therefore, the following Equation may be satisfied. The following equation shows a condition for scheduling based on n+k, and a condition for scheduling based on n+7, in TDD #0.

$$TDD configuration \#0 and normal HARQ operation \\ n + k \{ \begin{matrix}MSB of UL index is set to 1 by PDCCH \\ \begin{matrix}PHICH is received in subframe \#0 or 5 \\ coresponding to {I}_{PHICH} = 0\end{matrix}\end{matrix} \\ n + 7 \{ \begin{matrix}LSB of UL index is set to 1 by PDCCH \\ \begin{matrix}PHICH is received in subframe \#0 or 5 \\ coresponding to {I}_{PHICH} = 1\end{matrix} \\ PHICH is received in subframe \#1 or 6\end{matrix} \\ \underline{n + k} and \underline{n + 7} ( Both MSB and LSB of UL index is set \\ to 1 by PDCCH \qquad [ Equation 1 ]$$

That is, when the condition for operating TDD#0 based on n+k is satisfied, scheduling is executed based on k set in Table 2. However, when the condition for operating TDD#0 based on n+7 is satisfied, an uplink grant transmitted in the TDD#0 may be uplink transmitted in an uplink subframe corresponding to a 7th timing.

Therefore, when n+k of Equation 1 is applied, in the embodiment of FIG. 9, the UL grant/PHICH transmission may be executed in a subframe that is four subframes after a subframe #0, based on the k, that is, the subframe #4. However, it is a DL subframe in an actual configuration and thus, scheduling is not executed. When n+7 of Equation 1 is applied, a timing of n+7 is used based on a predetermined condition. The timing may use a reference PUSCH timing.

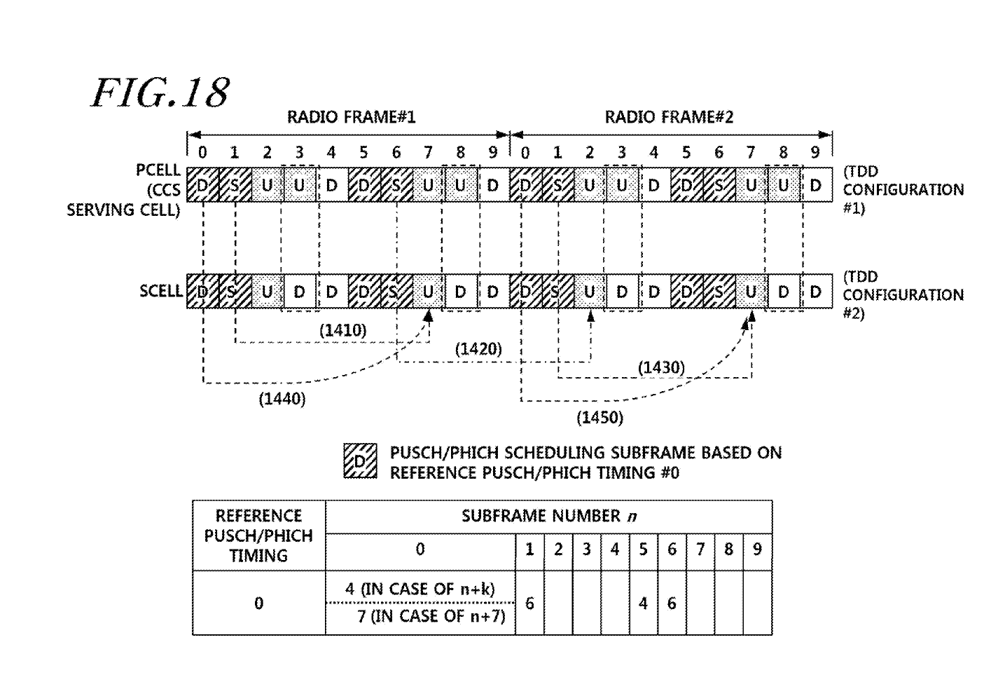

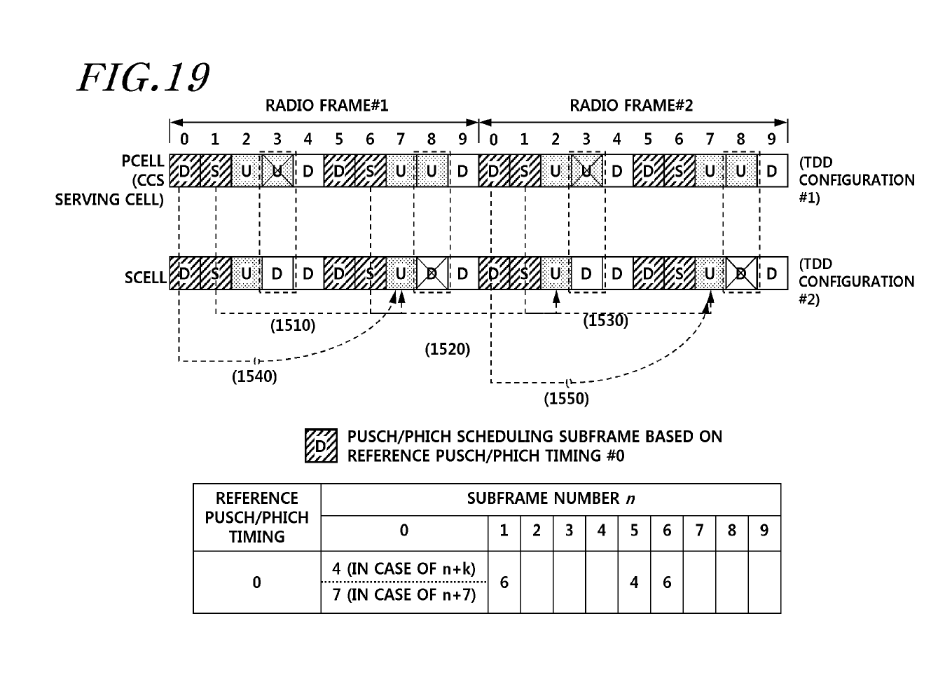

This will be described with reference to FIGS. 18 and 19.

FIG. 18 is a diagram illustrating a case in which a reference PUSCH/PHICH configuration is TDD #0, and “n+7” of Equation 1 is set, according to an embodiment of the present invention. In FIG. 9, the reference PUSCH/PHICH configuration is #0, and the n+k scheme is applied.

In FIG. 18, the diagrams 1410, 1420, and 1430 are identical to the diagrams 910, 920, and 930 of FIG. 9.

In the present specifications, n+7 of TDD#0 is applied and thus, PUSCH transmission is scheduled for a subframe #7, in a subframe #0. This is shown in the diagrams 1440 and 1450.

FIG. 19 is another diagram illustrating a case in which a reference PUSCH/PHICH configuration is TDD #0, and “n+7” of Equation 1 is set, according to an embodiment of the present invention. In FIG. 11, the reference PUSCH/PHICH configuration is #0, and the n+k scheme is applied.

In FIG. 19, the diagrams 1510, 1520, and 1530 are identical to the diagrams 1110, 1120, and 1130 of FIG. 11.

In the present specifications, n+7 of TDD#0 is applied and thus, PUSCH transmission is scheduled for a subframe #7, in a subframe #0. This is shown in the diagrams 1540 and 1550.

In FIGS. 9 through 13 and FIGS. 18 and 19, when the present invention is applied, a separate configuration of a reference PUSCH/PHICH scheduling timing may be applied even when CCS is set n an inter-band CA environment. Hereinafter, a process of sharing information associated with a reference PUSCH/PHICH scheduling timing between an eNB and a UE will be described.

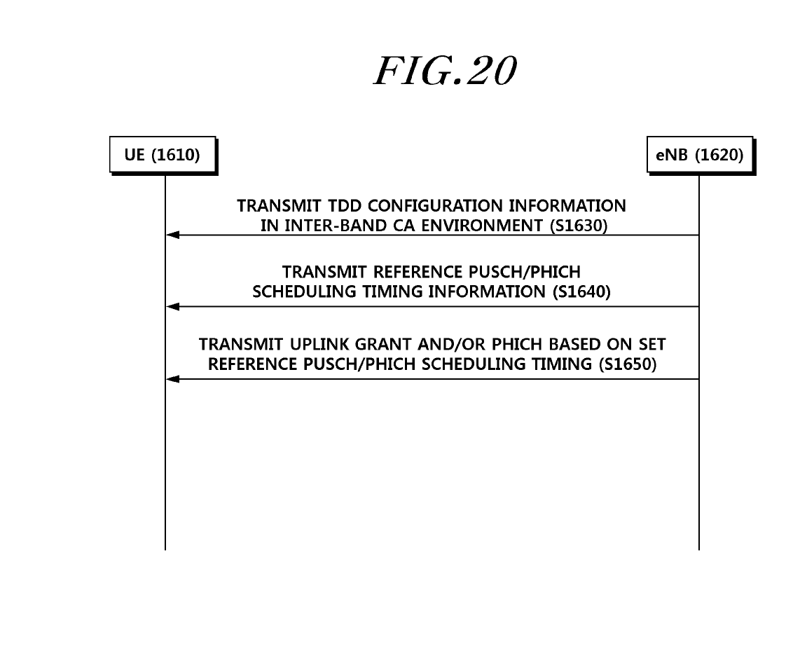

FIG. 20 is a diagram illustrating a process in which an eNB executes signaling of reference PUSCH/PHICH scheduling timing information to a UE according to an embodiment of the present invention.

First, a UE 1610 receives, from an eNB 1620, information associated with a TDD configuration of an inter-band CA environment in operation S1630. This may be executed when the UE 1610 accesses a network managed by the eNB 1620.

The eNB 1620 and the UE 1610 generate, based on each TDD configuration, values of candidates of a reference PUSCH/PHICH scheduling timing as shown in Table 5, or table information may be predefined.

Subsequently, the eNB 1620 indicates appropriate reference PUSCH/PHICH scheduling timing information from among candidates of a reference PUSCH/PHICH scheduling timing in a UE-specific manner, based on a channel environment and geographical position of each UE 1610, in operation S1640. Signaling for the indication may be transmitted through an RRC or a PDCCH. The eNB 1620 directly indicates the reference PUSCH/PHICH timing value through the RRC or the PDCCH, both the eNB 1620 and the UE 1610 may indicate the reference PUSCH/PHICH timing information based on Table 5, and the eNB 1620 may indicate the reference PUSCH/PHICH timing information based on an offset value.

That is, as shown in FIGS. 9 through 12, when a PCell is TDD #1, and an SCell is TDD#2, the candidates of a reference PUSCH/PHICH timing of Table 5 may be {0, 1, 6}. Among the candidates, when the eNB 1620 directly selects a TDD#6, the eNB 1620 may signal information indicating TDD#6 (for example, integer “6”) to the UE 1610, or the eNB 1620 may signal an offset of 5 (the offset of 5 between the reference timing of TDD#6 and TDD#1 of the PCell) based on a TDD configuration value of the PCell of the UE 1610.

According to another method, an offset may be given by numbering the candidates of Table 5. That is, the TDD #0 is first, the TDD #1 is second, and the TDD #6 is third among the candidates {0, 1, 6} and, since the UE 1610 has checked the candidate values of Table 5, the eNB 1620 may signal a value of 3 to indicate the TDD #6.

A criterion used when the eNB 1620 determines a reference PUSCH/PHICH timing to be set for each UE includes i) a channel environment of each UE, ii) an amount of UL data traffic required for each UE, in) inter-cell interference with respect to a PDCCH considered in a cell deployment environment, and the like. The eNB 1620 may set a reference PUSCH/PHICH timing appropriate for each UE, with respect to all the UEs of a full duplex/half duplex transmission mode in a cell, so as to draw an optimal capacity.

All the corresponding UEs of the full duplex/half duplex transmission mode operate a PDSCH HARQ operation with a reference PUSCH/PHICH timing, based on the signaling information.

That is, based on the reference PUSCH/PHICH scheduling timing set in operation S1640, an uplink grant and/or PHICH is transmitted (UL grant and/or PHICH) in operation S1650.

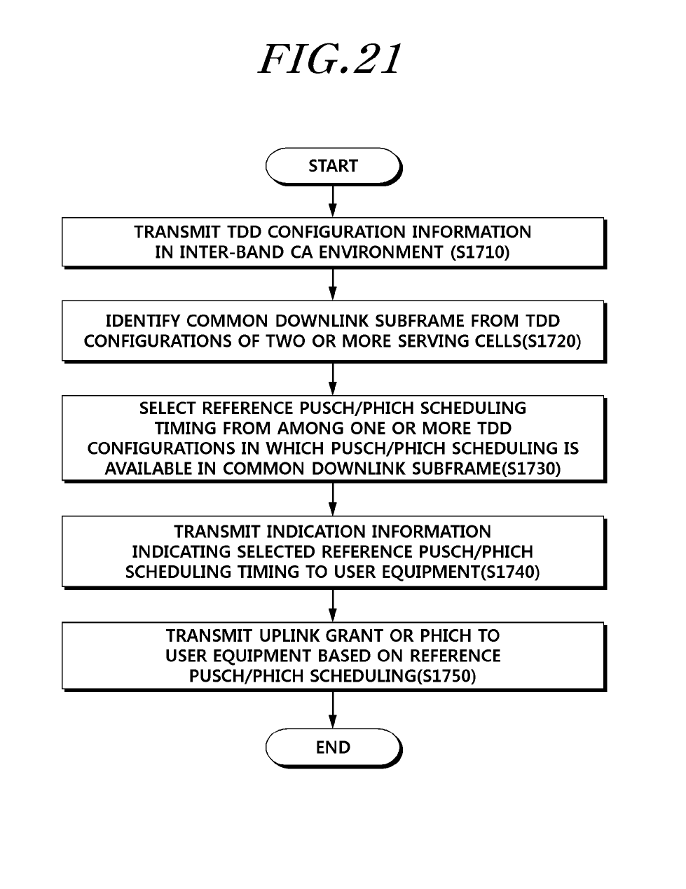

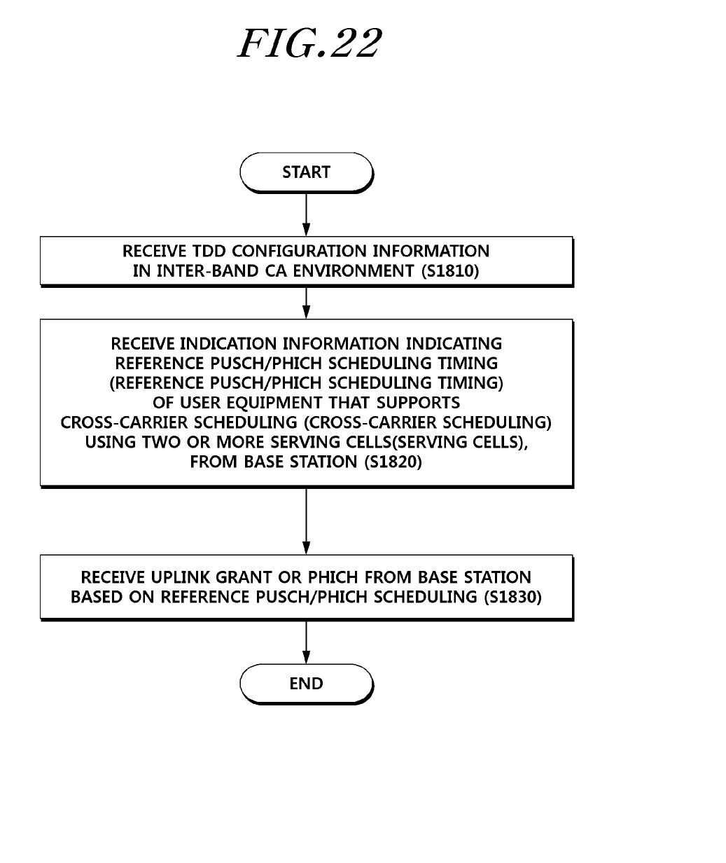

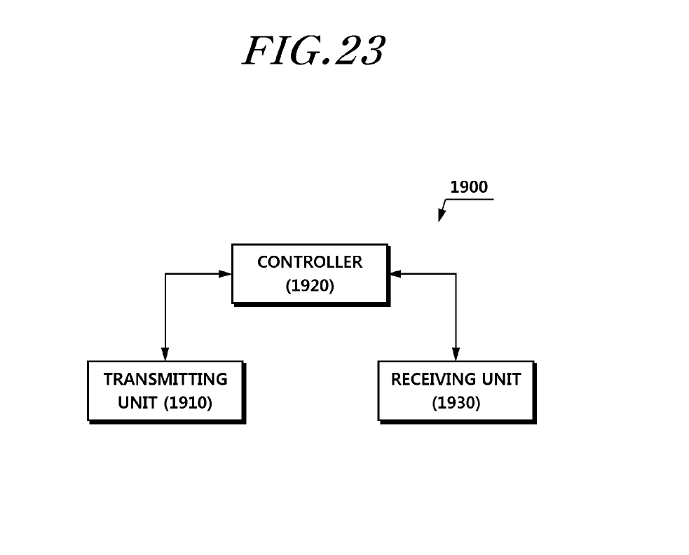

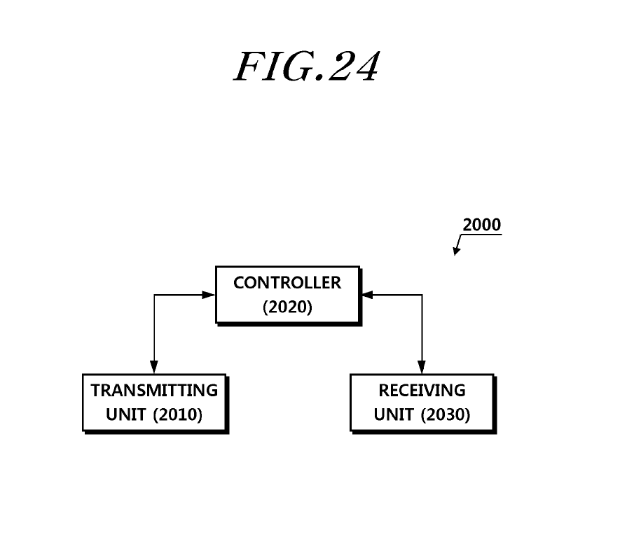

FIG. 21 is a diagram illustrating a process in which a base station provides a reference PUSCH/PHICH scheduling timing to a user equipment in an inter-band TDD transmission scheme, and accordingly, transmits an uplink grant and/or PHICH, according to an embodiment of the present invention.

First, a base station transmits TDD configuration information in an inter-band CA environment in operation S1710. In this process, cross-carrier scheduling is set with respect to two or more serving cells. Subsequently, the base station selects a reference PUSCH/PHICH scheduling timing of a user equipment that supports cross-carrier scheduling. In particular, the base station identifies a common downlink subframe from the TDD configurations of the two or more serving cells in operation S1730. The base station selects a reference PUSCH/PHICH scheduling timing from among one or more TDD configurations where PUSCH/PHICH scheduling is available in the common downlink subframe, in operation S1730. This indicates selection of a reference PUSCH/PHICH scheduling timing that may execute transmission in a common downlink subframe, from among existing PUSCH/PHICH scheduling timings. One of the candidates of a reference PUSCH/PHICH scheduling timing may be selected by applying Table 5 with respect to the types of two or more serving cells. The criterion for the selection may be a predetermined criterion, or the reference PUSCH/PHICH scheduling timing may be selected from among the candidates (the one or more TDD configurations) based on at least one of a channel environment of the user equipment, a geographical position, and a size of transmission traffic of the user equipment. That is, a reference PUSCH/PHICH scheduling timing that the user equipment is actually able to use from among the candidates may be selected. The selection is not always required, and the base station and the user equipment may omit a separate signaling process by setting only one reference PUSCH/PHICH scheduling timing applicable for each TDD configuration of each serving cell. In this instance, when the TDD configuration information of operation S1710 is shared between the base station and the user equipment, the user equipment may determine a reference PUSCH/PHICH scheduling timing to be applied without the signaling of separate indication information.

Subsequently, the base station transmits, to the user equipment, indication information indicating the selected reference PUSCH/PHICH scheduling timing in operation S1740. The indication information may be indication information that directly indicates the reference PUSCH/PHICH scheduling timing, or may be indication information that indicates offset information associated with a TDD configuration set in the user equipment. Subsequently, based on the reference PUSCH/PHICH scheduling timing, the base station transmits an uplink grant or a PHICH to the user equipment in operation S1740.

The operations of FIG. 17 may be operated by a base station such as an eNB, and an accurate reference timing may be signaled by the base station or may be predefined.

The case in which the PUSCH/PHICH scheduling timing is predefined will be described in detail.

When the PUSCH/PHICH scheduling timing is predefined, a base station and a user equipment may be aware of the PUSCH/PHICH scheduling timing information without separate signaling between the base station and the user equipment.

In this instance, the base station transmits an uplink grant or a PHICH to the user equipment, and the user equipment transmits a PUSCH to the base station based on the predefined PUSCH/PHICH scheduling timing.

The base station and the user equipment support cross-carrier scheduling using two or more serving cells. In the case of the two or more serving cells, as described with reference to FIGS. 15 through 17, a PUSCH/PHICH scheduling timing of a scheduling cell is based on a PUSCH/PHICH scheduling timing of a TDD configuration of the scheduling cell, and a PUSCH/PHICH scheduling timing of a scheduled cell is based on the predetermined PUSCH/PHICH scheduling timing.

Also, as described in FIG. 16, when the scheduling cell has an uplink super set in comparison with the scheduled cell, or when a PUSCH HARQ RTT (Round Trip Time) of the TDD configuration of the scheduling cell is 10 ms (the case in which a pair of the TDD configurations of the scheduling cell and the scheduled cell corresponds to (1,2), (1,4), (1,5), (2,5), (3,4), (3,5), or (4,5)), the PUSCH/PHICH scheduling timing of the scheduled cell may be based on the PUSCH/PHICH scheduling timing of the scheduling cell, as the predetermined PUSCH/PHICH scheduling timing.

Also, as described in FIG. 17, when the scheduling cell corresponds to an uplink subset (UL subset) in comparison with the scheduled cell, or when a PUSCH HARQ RTT (Round Trip Time) of the TDD configuration of the scheduling cell is 10 ms (the case in which a pair of the TDD configurations of the scheduling cell and the scheduled cell corresponds to ((1,0), (1,6), (2,0), (2,1), (2,6), (3,0), (3,6), (4,0), (4,1), (4,3), (4,6), (5,0), (5,1), (5,2), (5,3), (5,4), (5,6), or (6,0)), the PUSCH/PHICH scheduling timing of the scheduled cell may be based on the PUSCH/PHICH scheduling timing that is based on the TDD configuration of the scheduled cell, as the predetermined PUSCH/PHICH scheduling timing.

FIG. 18 is a diagram illustrating a process in which a user equipment of an inter-band TDD transmission scheme receives indication information associated with a reference PUSCH/PHICH scheduling timing from a base station, and accordingly, receives an uplink grant and/or PHICH, according to an embodiment of the present invention.

First, a user equipment receives TDD configuration information in an inter-band CA environment in operation S1810. In this process, cross-carrier scheduling is set with respect to two or more serving cells. Subsequently, the user equipment that supports cross-carrier scheduling receives information indicating a reference PUSCH/PHICH scheduling timing from a base station, in operation S1820. In particular, the reference PUSCH/PHICH scheduling timing may be selected by the base station from the TDD configurations where a PUSCH/PHICH scheduling is available in a common downlink subframe identified from TDD configurations of the two or more serving cells, or may be agreed on, in advance, with the user equipment. When the scheduling timing is selected by the base station, the base station may apply Table 5 with respect to the type of two or more serving cells, to select one of the candidates of a reference PUSCH/PHICH scheduling timing. That is, it may be selected from among the one or more TDD configurations, based on at least one of a channel environment of the user equipment, a geographical position, and a size of transmission traffic of the user equipment.

The indication information received in operation S1820 may be indication information that directly indicates the reference PUSCH/PHICH scheduling timing, or may be indication information that indicates offset information associated with a TDD configuration set in the user equipment. Subsequently, based on the reference PUSCH/PHICH scheduling timing, the use equipment receives an uplink grant or a PHICH from the base station in operation S1830.

FIG. 19 is a diagram illustrating a configuration of a base station according to an embodiment of the present invention. A base station provides a user equipment with a reference PUSCH/PHICH scheduling timing in an inter-band TDD transmission scheme, and accordingly, executes a function of transmitting an uplink grant and/or PHICH. A base station 1900 of FIG. 19 is a base station that controls two or more bands of different TDD (Time Division Duplex) configurations. A transmitting unit 1910, a controller 1920, and a receiving unit 1930 are included as component elements.

The controller 1920 selects a reference PUSCH/PHICH scheduling timing of a user equipment that supports cross-carrier scheduling using two or more serving cells. In particular, the controller 1920 controls the transmitting unit 1910 to transmit TDD configuration information in an inter-band CA environment. In this process, cross-carrier scheduling is set with respect to two or more serving cells. Subsequently, the base station selects a reference PUSCH/PHICH scheduling timing of a user equipment that supports cross-carrier scheduling. In particular, the controller 1920 identifies a common downlink subframe from the TDD configurations of the two or more serving cells. The controller 1920 selects a reference PUSCH/PHICH scheduling timing from among one or more TDD configurations where PUSCH/PHICH scheduling is available in the common downlink subframe. This indicates selection of a reference PUSCH/PHICH scheduling timing that may execute transmission in a common downlink subframe, from among existing PUSCH/PHICH scheduling timings. One of the candidates of a reference PUSCH/PHICH scheduling timing may be selected by applying Table 5 with respect to the types of two or more serving cells. The controller 1920 may select the reference PUSCH/PHICH scheduling timing as follows. That is, a criterion agreed on in advance with the user equipment or a predefined criterion may be used, or the reference PUSCH/PHICH scheduling timing may be selected from among the candidates (the one or more TDD configurations) based on at least one of a channel environment of the user equipment, a geographical position, and a size of transmission traffic of the user equipment. That is, the controller 1920 selects a reference PUSCH/PHICH scheduling timing that the user equipment is actually able to use, from among the candidates. The selection is not always required, and the base station and the user equipment may omit a separate signaling process by setting only one reference PUSCH/PHICH scheduling timing that is applicable for each TDD configuration of each serving cell. When TDD configuration information is shared between the base station and the user equipment, the user equipment may determine a reference PUSCH/PHICH scheduling timing to be applied without the signaling of separate indication information.

Subsequently, the transmitting unit 1910 transmits, to the user equipment, indication information indicating the selected reference PUSCH/PHICH scheduling timing. The indication information may be indication information that directly indicates the reference PUSCH/PHICH scheduling timing, or may be indication information that indicates offset information associated with a TDD configuration set in the user equipment. Subsequently, based on the reference PUSCH/PHICH scheduling timing, the transmitting unit 1910 transmits an uplink grant or a PHICH to the user equipment. The receiving unit 1930 receives an uplink from the user equipment, based on the reference PUSCH/PHICH scheduling timing.

FIG. 20 is a diagram illustrating a configuration of a user equipment according to an embodiment of the present invention. A user equipment receives, from a base station, a reference PUSCH/PHICH scheduling timing in an inter-band TDD transmission scheme, and accordingly, executes a function of receiving an uplink grant and/or PHICH and transmitting an uplink accordingly. A user equipment 2000 of FIG. 20 wirelessly accesses a base station that controls two or more bands of different TDD (Time Division Duplex) configurations. A transmitting unit 2010, a controller 2020, and a receiving unit 2030 are included as component elements.

The transmitting unit 2010 transmits an uplink based on a reference PUSCH/PHICH scheduling timing, as described earlier. The receiving unit 2030 receives indication information of the reference PUSCH/PHICH scheduling timing from the base station, and the controller 2020 controls the transmitting unit 2010 and the receiving unit 2030.

First, the receiving unit 2030 receives TDD configuration information in an inter-band CA environment. In this process, cross-carrier scheduling is set with respect to two or more serving cells. The receiving unit 2030 of the user equipment that supports cross-carrier scheduling receives information indicating a reference PUSCH/PHICH scheduling timing from the base station. In particular, the reference PUSCH/PHICH scheduling timing may be selected by the base station from the TDD configurations where a PUSCH/PHICH scheduling is available in a common downlink subframe identified from TDD configurations of the two or more serving cells, or may be agreed on in advance, with the user equipment. When the scheduling timing is selected by the base station, the base station may apply Table 5 with respect to the type of two or more serving cells to select one of the candidates of a reference PUSCH/PHICH scheduling timing. That is, it may be selected from among the one or more TDD configurations, based on at least one of a channel environment of the user equipment, a geographical position, and a size of transmission traffic of the user equipment.

The indication information received by the receiving unit 2030 may be indication information that directly indicates the reference PUSCH/PHICH scheduling timing, or may be indication information that indicates offset information associated with a TDD configuration set in the user equipment.

Subsequently, the controller 2020 controls the receiving unit 2030 to receive an uplink grant or a PHICH from the base station based on the reference PUSCH/PHICH scheduling timing, and controls the transmitting unit 2010 to transmit an uplink based on the reference PUSCH/PHICH scheduling timing.

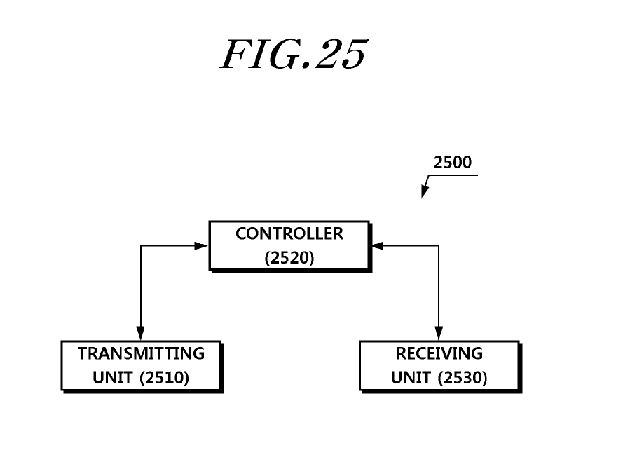

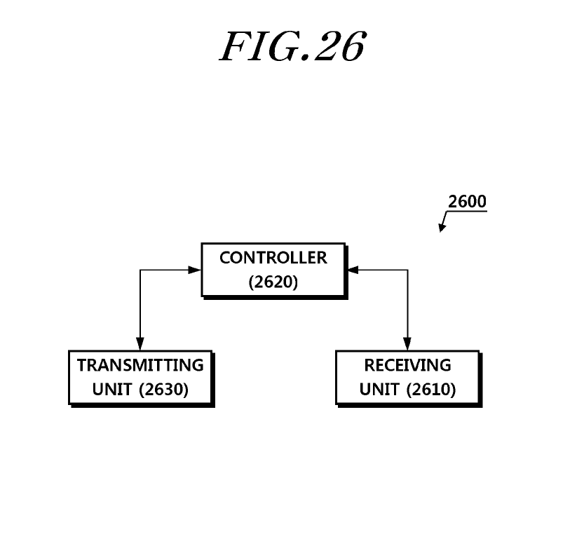

FIGS. 25 and 26 are block diagrams of a base station and a user equipment according to embodiments described with reference to FIGS. 15 through 17.

Referring to FIG. 25, a base station 2500 may include a transmitting unit 2510 that transmits an uplink grant or a PHICH (Physical Hybrid ARQ Indicator Channel) to a user equipment which supports cross-carrier scheduling using two or more serving cells, a controller 2520 that controls a PUSCH (Physical Uplink Shared Channel)/PHICH scheduling timing of a scheduling cell of the two or more serving cells to follow a PUSCH/PHICH scheduling timing that is based on a TDD configuration of the scheduling cell, and controls a PUSCH/PHICH scheduling timing of a scheduled cell to follow a predetermined PUSCH/PHICH scheduling timing, and a receiving unit 2530 that receives a PUSCH from the user equipment based on the PUSCH/PHICH scheduling timing.

Referring to FIG. 26, a user equipment 2600 may include a receiving unit 2610 that receives an uplink grant or a PHICH (Physical Hybrid ARQ Indicator Channel) from a base station which supports cross-carrier scheduling using two or more serving cells, a controller 2620 that controls a PUSCH (Physical Uplink Shared Channel)/PHICH scheduling timing of a scheduling cell of the two or more serving cells to follow a PUSCH/PHICH scheduling timing that is based on a TDD configuration of the scheduling cell, and controls a PUSCH/PHICH scheduling timing of a scheduled cell to follow a predetermined PUSCH/PHICH scheduling timing, and a transmitting unit 2630 that transmits a PUSCH to the base station based on the PUSCH/PHICH scheduling timing.

Table 5 shows candidates of a reference PUSCH/PHICH scheduling timing in two different TDD configurations. Although a plurality of different TDD configurations are used, the present invention may be applicable. That is, in an inter-band CA environment formed of three bands, the bands have different TDD configurations, and a single cell exists in each band and a TDD configuration is different for each cell. Even in this instance, a common downlink subframe is calculated for each TDD configuration, and candidates of a reference PUSCH/PHICH scheduling timing that is applicable to the corresponding downlink subframe may be selected.

For example, as shown in Table 6, a common downlink subframe in three different TDD configurations and the candidates of a reference PUSCH/PHICH scheduling timing are as follows.

TABLE 6

| | | | | Reference |
|---|---|---|---|---|
| TDD config- | TDD config- | TDD config- | | PUSCH/PHICH |
| uration of | uration of | uration of | Common DL | scheduling timing |
| first cell | second cell | third cell | subframe | candidates |
| 0 | 1 | 2 | 0, 1, 5, 6 | {0} |
| 0 | 1 | 3 | 0, 1, 5, 6 | {0} |
| 0 | 1 | 4 | 0, 1, 5, 6 | {0} |
| 0 | 1 | 5 | 0, 1, 5, 6 | {0} |
| 0 | 1 | 6 | 0, 1, 5, 6 | {0} |
| 0 | 2 | 3 | 0, 1, 5, 6 | {0} |
| 0 | 2 | 4 | 0, 1, 5, 6 | {0} |
| 0 | 2 | 5 | 0, 1, 5, 6 | {0} |
| 0 | 2 | 6 | 0, 1, 5, 6 | {0} |
| 0 | 3 | 4 | 0, 1, 5, 6 | {0} |
| 0 | 3 | 5 | 0, 1, 5, 6 | {0} |
| 0 | 3 | 6 | 0, 1, 5, 6 | {0} |
| 0 | 4 | 5 | 0, 1, 5, 6 | {0} |
| 0 | 4 | 6 | 0, 1, 5, 6 | {0} |
| 0 | 5 | 6 | 0, 1, 5, 6 | {0} |
| 1 | 2 | 3 | 0, 1, 5, 6, 9 | {0, 6} |
| 1 | 2 | 4 | 0, 1, 5, 6, 9 | {0, 6} |
| 1 | 2 | 5 | 0, 1, 5, 6, 9 | {0, 6} |
| 1 | 2 | 6 | 0, 1, 5, 6, 9 | {0, 6} |
| 1 | 3 | 4 | 0, 1, 5, 6, 9 | {0, 6} |
| 1 | 3 | 5 | 0, 1, 5, 6, 9 | {0, 6} |
| 1 | 3 | 6 | 0, 1, 5, 6, 9 | {0, 6} |
| 1 | 4 | 5 | 0, 1, 4, 5, 6, 9 | {0, 1, 6} |
| 1 | 4 | 6 | 0, 1, 5, 6, 9 | {0, 6} |
| 1 | 5 | 6 | 0, 1, 5, 6, 9 | {0, 6} |
| 2 | 3 | 4 | 0, 1, 5, 6, 9 | {0, 6} |
| 2 | 3 | 5 | 0, 1, 5, 6, 8, 9 | {0, 3, 4, 5, 6\| |
| 2 | 3 | 6 | 0, 1, 5, 6, 9 | {0, 6} |
| 2 | 4 | 5 | 0, 1, 4, 5, 6, 8, 9 | {0, 1, 3, 4, 5, 6} |
| 2 | 4 | 6 | 0, 1, 5, 6, 9 | {0, 6} |
| 2 | 5 | 6 | 0, 1, 5, 6, 9 | {0, 6} |
| 3 | 4 | 5 | 0, 1, 5, 6, 7, 8, 9 | {0, 3, 4, 5, 6} |
| 3 | 4 | 6 | 0, 1, 5, 6, 9 | {0, 6} |
| 3 | 5 | 6 | 0, 1, 5, 6, 9 | {0, 6} |
| 4 | 5 | 6 | 0, 1, 5, 6, 9 | {0, 6} |

The present invention modifies and applies an existing timing rule, so as to support CCS in an inter-band CA environment. Accordingly, a limit on TDD configurations of serving cells in the inter-band CA environment may be overcome. Also, the application may be a common solution, which may be commonly applied to all TDD configurations/transmission modes of a UE.

Although the technical idea of the present invention has been described for illustrative purposes, those skilled in the art will appreciate that various modifications and changes are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of applying a PUSCH/PHICH (Physical Uplink Shared Channel/Physical Hybrid Automatic Repeat Request Indicator Channel) scheduling timing of a base station that controls two or more bands having different Time Division Duplex (TDD) configurations, based on an inter-band TDD transmission scheme, the method comprising:
transmitting an uplink grant or a PHICH to a user equipment that supports cross-carrier scheduling using two or more serving cells; and
receiving a PUSCH from the user equipment, based on at least one PUSCH/PHICH scheduling timing of the two or more serving cells,
wherein a PUSCH/PHICH scheduling timing of a scheduling cell of the two or more serving cells is based on a PUSCH/PHICH scheduling timing that is based on a TDD configuration of the scheduling cell, and a PUSCH/PHICH scheduling timing of a scheduled cell is based on a predetermined PUSCH/PHICH scheduling timing.

2. The method as claimed in claim 1, wherein, when the scheduling cell has an uplink super set in comparison with the scheduled cell, or when a PUSCH Hybrid Automatic Repeat Request Round Trip Time (HARQ RTT) of the TDD configuration of the scheduling cell is 10 ms, the predetermined PUSCH/PHICH scheduling timing is the PUSCH/PHICH scheduling timing of the scheduling cell.

3. The method as claimed in claim 1, wherein, when a pair of the TDD configurations of the scheduling cell and the scheduled cell is (1,2), (1,4), (1,5), (2,5), (3,4), (3,5), or (4,5), the predetermined PUSCH/PHICH scheduling timing is the PUSCH/PHICH scheduling timing of the scheduling cell.

4. The method as claimed in claim 1, wherein, when the scheduling cell corresponds to an uplink subset (UL subset) in comparison with the scheduled cell, or when a PUSCH Hybrid Automatic Repeat Request Round Trip Time (HARQ RTT) of the TDD configuration of the scheduling cell is 10 ms, the predetermined PUSCH/PHICH scheduling timing is a PUSCH/PHICH scheduling timing that is based on a TDD configuration of the scheduled cell.

5. The method as claimed in claim 1, wherein, when a pair of the TDD configurations of the scheduling cell and the scheduled cell is (1,0), (1,6), (2,0), (2,1), (2,6), (3,0), (3,6), (4,0), (4,1), (4,3), (4,6), (5,0), (5,1), (5,2), (5,3), (5,4), (5,6), or (6,0), the predetermined PUSCH/PHICH scheduling timing is a PUSCH/PHICH scheduling timing that is based on a TDD configuration of the scheduled cell.

6. A method of applying a PUSCH/PHICH (Physical Uplink Shared Channel/Physical Hybrid Automatic Repeat Request Indicator Channel) scheduling timing of a user equipment that transmits and receives data in two or more bands having different TDD (Time Division Duplex) configurations, based on an inter-band TDD transmission scheme, the method comprising:
receiving an uplink grant or a PHICH from a base station that supports cross-carrier scheduling using two or more serving cells; and
transmitting a PUSCH to the base station based on at least one PUSCH/PHICH scheduling timing of the two or more serving cells,
wherein a PUSCH/PHICH scheduling timing of a scheduling cell of the two or more serving cells is based on a PUSCH/PHICH scheduling timing that is based on a TDD configuration of the scheduling cell, and a PUSCH/PHICH scheduling timing of a scheduled cell is based on a predetermined PUSCH/PHICH scheduling timing.

7. The method as claimed in claim 6, wherein, when the scheduling cell has an uplink super set in comparison with the scheduled cell, or when a PUSCH Hybrid Automatic Repeat Request Round Trip Time (HARQ RTT) of the TDD configuration of the scheduling cell is 10 ms, the predetermined PUSCH/PHICH scheduling timing is a PUSCH/PHICH scheduling timing of the scheduling cell.

8. The method as claimed in claim 6, wherein, when a pair of TDD configurations of the scheduling cell and the scheduled cell is (1,2), (1,4), (1,5), (2,5), (3,4), (3,5), or (4,5), the predetermined PUSCH/PHICH scheduling timing is a PUSCH/PHICH scheduling timing of the scheduling cell.

9. The method as claimed in claim 6, wherein, when the scheduling cell corresponds to an uplink subset (UL subset) in comparison with the scheduled cell, or when a PUSCH Hybrid Automatic Repeat Request Round Trip Time (HARQ RTT) of a TDD configuration of the scheduling cell is 10 ms, the predetermined PUSCH/PHICH scheduling timing is a PUSCH/PHICH scheduling timing that is based on a TDD configuration of the scheduled cell.

10. The method as claimed in claim 6, wherein, when a pair of TDD configurations of the scheduling cell and the scheduled cell is (1,0), (1,6), (2,0), (2,1), (2,6), (3,0), (3,6), (4,0), (4,1), (4,3), (4,6), (5,0), (5,1), (5,2), (5,3), (5,4), (5,6), or (6,0), the predetermined PUSCH/PHICH scheduling timing is a PUSCH/PHICH scheduling timing that is based on a TDD configuration of the scheduled cell.

11. A base station that controls two or more bands having different TDD (Time Division Duplex) configurations, the base station comprising:
a transmitting unit that transmits an uplink grant or a Physical Hybrid Automatic Repeat Request Indicator Channel (PHICH) to a user equipment that supports cross-carrier scheduling using two or more serving cells;
a receiving unit that receives a Physical Uplink Shared Channel (PUSCH) from the user equipment based on at least one PUSCH/PHICH scheduling timing of the two or more serving cells; and
a controller that executes a control so that a PUSCH/PHICH scheduling timing of a scheduling cell of the two or more serving cells is based on a PUSCH/PHICH scheduling timing that is based on a TDD configuration of the scheduling cell, and a PUSCH/PHICH scheduling timing of a scheduled cell is based on a predetermined PUSCH/PHICH scheduling timing.

12. The base station as claimed in claim 11, wherein, when the scheduling cell has an uplink super set in comparison with the scheduled cell, or when a PUSCH Hybrid Automatic Repeat Request Round Trip Time (HARQ RTT) of a TDD configuration of the scheduling cell is 10 ms, the predetermined PUSCH/PHICH scheduling timing is a PUSCH/PHICH scheduling timing of the scheduling cell.

13. The base station as claimed in claim 11, wherein, when a pair of TDD configurations of the scheduling cell and the scheduled cell is (1,2), (1,4), (1,5), (2,5), (3,4), (3,5), or (4,5), the predetermined PUSCH/PHICH scheduling timing is the PUSCH/PHICH scheduling timing of the scheduling cell.

14. The base station as claimed in claim 11, wherein, when the scheduling cell corresponds to an uplink subset (UL subset) in comparison with the scheduled cell, or when a PUSCH Hybrid Automatic Repeat Request Round Trip Time (HARQ RTT) of a TDD configuration of the scheduling cell is 10 ms, the predetermined PUSCH/PHICH scheduling timing is a PUSCH/PHICH scheduling timing that is based on a TDD configuration of the scheduled cell.

15. The base station as claimed in claim 11, wherein, when a pair of TDD configurations of the scheduling cell and the scheduled cell is (1,0), (1,6), (2,0), (2,1), (2,6), (3,0), (3,6), (4,0), (4,1), (4,3), (4,6), (5,0), (5,1), (5,2), (5,3), (5,4), (5,6), or (6,0), the predetermined PUSCH/PHICH scheduling timing is a PUSCH/PHICH scheduling timing that is based on a TDD configuration of the scheduled cell.

16. A user equipment that transmits and receives data in two or more bands having different TDD (Time Division Duplex) configurations, the user equipment comprising:
a receiving unit that receives an uplink grant or a Physical Hybrid Automatic Repeat Request Indicator Channel (PHICH) from a base station that supports cross-carrier scheduling using two or more serving cells;
a transmitting unit that transmits a Physical Uplink Shared Channel (PUSCH) to the base station based on at least one PUSCH/PHICH scheduling timing of the two or more serving cells; and
a controller that executes a control so that a PUSCH/PHICH scheduling timing of a scheduling cell of the two or more serving cells is based on a PUSCH/PHICH scheduling timing that is based on a TDD configuration of the scheduling cell, and a PUSCH/PHICH scheduling timing of a scheduled cell is based on a predetermined PUSCH/PHICH scheduling timing.

17. The user equipment as claimed in claim 16, wherein, when the scheduling cell has an uplink super set in comparison with the scheduled cell, or when a PUSCH Hybrid Automatic Repeat Request Round Trip Time (HARQ RTT) of a TDD configuration of the scheduling cell is 10 ms, the predetermined PUSCH/PHICH scheduling timing is the PUSCH/PHICH scheduling timing of the scheduling cell.

18. The user equipment as claimed in claim 16, wherein, when a pair of TDD configurations of the scheduling cell and the scheduled cell is (1,2), (1,4), (1,5), (2,5), (3,4), (3,5), or (4,5), the predetermined PUSCH/PHICH scheduling timing is the PUSCH/PHICH scheduling timing of the scheduling cell.

19. The user equipment as claimed in claim 16, wherein, when the scheduling cell corresponds to an uplink subset (UL subset) in comparison with the scheduled cell, or when a PUSCH Hybrid Automatic Repeat Request Round Trip Time (HARQ RTT) of a TDD configuration of the scheduling cell is 10 ms, the predetermined PUSCH/PHICH scheduling timing is a PUSCH/PHICH scheduling timing that is based on a TDD configuration of the scheduled cell.

20. The user equipment as claimed in claim 16, wherein, when a pair of TDD configurations of the scheduling cell and the scheduled cell is (1,0), (1,6), (2,0), (2,1), (2,6), (3,0), (3,6), (4,0), (4,1), (4,3), (4,6), (5,0), (5,1), (5,2), (5,3), (5,4), (5,6), or (6,0), the predetermined PUSCH/PHICH scheduling timing is a PUSCH/PHICH scheduling timing that is based on a TDD configuration of the scheduled cell.
